(19) United States
(12) Patent Application Publication
(10) Pub. No.: US 2025/0321366 A1
(43) Pub. Date: Oct. 16, 2025

(54) FLUID LENS HAVING VARIABLE-STIFFNESS SUPPORT

(71) Applicant: Meta Platforms Technologies, LLC, Menlo Park, CA (US)

(72) Inventors: Spencer Allan Wells, Seattle, WA (US); Eugene Cho, Seattle, WA (US); Christopher Stipe, Woodinville, WA (US); Nagi Hosni Elabbasi, Southborough, MA (US); Kenneth Alexander Diest, Kirkland, WA (US); Giancarlo Sigurd Sante Nucci, Seattle, WA (US); John Cooke, Bothell, WA (US); Andrew John Ouderkirk, Kirkland, WA (US)

(21) Appl. No.: 17/880,114

(22) Filed: Aug. 3, 2022

(51) Int. Cl. G02B 3/14; G02B 7/04; G02B 26/00

(52) U.S. Cl. CPC G02B 3/14; G02B 7/04; G02B 26/004

(57) ABSTRACT

A variable-stiffness spring member may be integrated into a deformable optical element, such as a fluid lens. An example fluid lens may include a substrate, an actuator, a fluid layer disposed between the substrate and the actuator, and a spring member disposed between the substrate and the actuator. The spring member may include a flexure that at least partially surrounds the fluid layer and a spring stiffness of the flexure may differ at each of at least two peripheral locations around the fluid layer. Various other devices, systems, and methods are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is a cross-sectional view showing a liquid lens according to some embodiments.

FIG. 1B is a cross-sectional view showing the liquid lens of FIG. 1A in an actuated state according to some embodiments.

FIG. 2A is a cross-sectional view showing a liquid lens according to some embodiments.

FIG. 2B is a cross-sectional view showing the liquid lens of FIG. 2A in an actuated state according to some embodiments.

FIG. 3 is a perspective view showing a variable-stiffness spring member according to some embodiments.

FIG. 4A is a cross-sectional view showing a liquid lens and illustrating a fluid pressure profile within the liquid lens according to some embodiments.

FIG. 4B is a plot illustrating prism values of uniform-stiffness spring members according to some embodiments.

FIG. 5 is a cross-sectional view showing a peripheral portion of a liquid lens according to some embodiments.

FIG. 6 is a cross-sectional view showing a peripheral portion of a liquid lens according to some embodiments.

FIG. 7A is a cross-sectional view showing a peripheral portion of a spring member according to some embodiments.

FIG. 7B is a cross-sectional view showing the spring member of FIG. 7A in a compressed state according to some embodiments.

FIG. 8 is a cross-sectional view showing a peripheral portion of a spring member according to some embodiments.

FIG. 9A is a plot showing gravity sag for a liquid lens having a uniform-stiffness edge support in an unactuated state according to some embodiments.

FIG. 9B is a plot showing cylinder values for the liquid lens of FIG. 9A in an actuated state according to some embodiments.

FIG. 9C is a plot showing gravity sag for a liquid lens having a uniform-stiffness edge support in an unactuated state according to some embodiments.

FIG. 9D is a plot showing cylinder values for the liquid lens of FIG. 9C in an actuated state according to some embodiments.

FIG. 10A is a plot showing gravity sag for a liquid lens having a variable-stiffness edge support in an unactuated state according to some embodiments.

FIG. 10B is a plot showing cylinder values for the liquid lens of FIG. 10A in an actuated state according to some embodiments.

FIG. 11 is a plot showing target deformation amounts for an actuated liquid lens according to some embodiments.

FIG. 12 is a map showing local stiffness target values for locations along the periphery of the liquid lens shown in FIG. 11 according to some embodiments.

FIG. 13 is a plot showing average optical power versus spring stiffness for liquid lenses having uniform-stiffness support members according to some embodiments.

FIG. 14 is a plot showing average cylinder versus spring stiffness for the liquid lenses of FIG. 13 according to some embodiments.

FIG. 15 is a plot showing average optical power versus spring stiffness for liquid lenses having nonuniform-stiffness support members according to some embodiments.

FIG. 16 is a plot showing average cylinder versus spring stiffness for the liquid lenses of FIG. 15 according to some embodiments.

FIG. 17A is a plot showing target deformation amounts at different locations of an actuated liquid lens having a centered sphere according to some embodiments.

FIG. 17B is a plot showing target deformation amounts at different locations of an actuated liquid lens having a decentered sphere according to some embodiments.

FIG. 17C is a plot showing target deformation amounts at different locations of an actuated liquid lens having a decentered sphere according to some embodiments.

FIG. 18 is a plot showing target relative stiffness values versus angular peripheral lens locations for various liquid lenses having variable-stiffness spring members according to some embodiments.

FIG. 19 is a plot showing target deformation amounts at different locations of an actuated liquid lens having a decentered sphere according to some embodiments.

FIG. 20 is a plot showing target relative stiffness values versus angular location along a lens perimeter for the decentered lens of FIG. 19.

FIG. 21 is a plot showing relative stiffness distributions versus angular peripheral lens locations for various liquid lenses having variable-stiffness spring members according to some embodiments.

FIG. 22 shows maximum spring stiffness values versus maximum/minimum perimeter stiffness values for liquid lenses having the stiffness distributions shown in FIG. 21.

FIG. 23 is a flow diagram of an exemplary method for producing a liquid lens according to some embodiments.

FIG. 24 is a flow diagram of an exemplary method for manufacturing a liquid lens according to some embodiments.

FIG. 25 is an illustration of exemplary augmented-reality glasses that may be used in connection with embodiments of this disclosure.

FIG. 26 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The fabrication of prescriptive lenses typically involves a casting process to generate a lens blank followed by milling or grinding and polishing to introduce customized, higher order curvature to at least one lens surface. Multiple such processing steps may increase the cost of manufacture, however, and inefficient production is especially an issue in ophthalmic lenses, where nearly 80% of the starting material may be lost to subtractive manufacture. In certain applications, the effective cost of prescriptive lenses may be improved through the production of adjustable lenses, which may be worn by multiple users having different prescriptions. Adjustable lenses may allow multiple users to share a common optical element or device, such as an augmented reality or virtual reality device or headset.

With an adjustable lens, a lens profile may be tuned in real-time or for a particular user to correct chromatic and monochromatic aberrations, including defocus, spherical aberrations, coma, astigmatism, field curvature, image distortions, and the like. The tuning of a lens may include the introduction of a spherical curvature during lens actuation. As used herein, the curve on the surface of a spherical lens, if extrapolated in all directions, would form a sphere. Liquid lenses may be utilized to quickly adjust a lens shape using an active member that can be actuated to produce a selected surface shape providing a selected lens power. Such adjustable liquid lenses may be used in either unactuated or actuated states depending on the situation. For example, when spherical correction is not needed, the liquid lens may be operated in an unactuated state. However, gravity may cause undesirable lens distortion in liquid lenses, particularly when the lenses are not actuated, due to the effect of gravity sag. Such gravity sag may be caused by pressure within the lens fluid that increases proceeding from an upper to a lower portion of the lens, causing distortion in the lens surface as the lens assumes a tilted profile due to the pressure gradient. Such lens distortion may negatively affect a user's view through such a lens, producing an undesired degree of cylinder and/or other visual aberrations when worn.

As will be described in greater detail herein, the instant disclosure relates to actuatable and transparent optical elements and methods for forming such optical elements. The optical elements may include one or more layers of an electroactive material where each layer is sandwiched between conductive electrodes. The disclosed optical elements may be configured to exhibit commercially-relevant electromechanical properties, including deformation response, long-term reliability, and integration compatibility, as well as beneficial optical properties, including low optical error in various states of actuation and formation of optical sphere in lenses having non-circular peripheries.

A dynamic actuator may be incorporated into a lens (or other optical element) and configured to create sphere, as well as a variable cylinder radius and axis in the lens in various examples. In some embodiments, the actuator may include one or more electromechanical layers with corresponding electrodes that are arranged to apply an electric field to provide actuation of the lens so as to produce a spherical lens shape. The actuator may be supported at its periphery by a variable-stiffness spring member that provides a sufficient amount of support to minimize aberrations due to gravity sag in an unactuated state while enabling formation of an acceptable sphere in an actuated state.

In some embodiments, an actuator may be used to create axisymmetric deflections, including spherical or aspherical contributions to an overall deflection profile, as well as non-axisymmetric (e.g., asymmetric) deflections, including cylindrical, prismatic, tip/tilt, and/or freeform contributions, thus enabling the dynamic formation of a high-quality prescriptive lens or other optical element.

One or more electromechanical layers within such actuators may include suitable electroactive materials, including organic materials such as electrostrictive or piezoelectric polymers or inorganic materials such as shape memory alloys or piezoceramics. According to certain embodiments, piezoelectric polymers and ceramics may be characterized by the piezoelectric coefficients d₃₁ and d₃₂, which correlate the displacement of charge per unit area (i.e., volume change) with an applied stress (i.e., applied electric field).

Electroactive materials may change their shape under the influence of an electric field and have been investigated for use in various technologies, including actuation, sensing and/or energy harvesting. Lightweight and conformable, various electroactive polymers and ceramics may be incorporated into wearable devices and are attractive candidates for emerging technologies including virtual reality/augmented reality devices where a comfortable, adjustable form factor is desired.

As used herein, “electroactive” materials, including piezoelectric and electrostrictive materials may, in some examples, refer to materials that exhibit a change in size or shape when stimulated by an external electric field. In the presence of an electric field (E-field), an electroactive material may deform (e.g., compress, elongate, bend, etc.) according to the magnitude and direction of the applied field.

In accordance with various embodiments, when exposed to an external electric field, an accumulated displacement of ions within an electroactive ceramic, for example, may produce an overall strain (elongation) in the direction of the field. That is, positive ions may be displaced in the direction of the field and negative ions displaced in the opposite direction. In turn, the thickness of the electroactive ceramic may be decreased in one or more orthogonal directions, as characterized by the Poisson's ratio.

Generation of such a field may be accomplished, for example, by placing the electroactive material between two electrodes, i.e., a primary electrode and a secondary electrode, each of which is at a different potential. As the potential difference (i.e., voltage difference) between the electrodes is increased or decreased (e.g., from zero potential) the amount of deformation may also increase, principally along electric field lines. This deformation may achieve saturation when a certain electrostatic field strength has been reached. With no electrostatic field, the electroactive material may be in its relaxed state undergoing no induced deformation, or stated equivalently, no induced strain, either internal or external. In an example actuator, plural electromechanical layers may be individually electroded such that a multilayer structure (e.g., a multilayer stack) includes alternating electrodes and electroactive layers.

In some instances, the physical origin of the compressive nature of many electroactive materials in the presence of an electrostatic field, being the force created between opposite electric charges, is that of the Maxwell stress, which is expressed mathematically with the Maxwell stress tensor. The level of strain or deformation induced by a given E-field is dependent on the square of the E-field strength, the dielectric constant of the electroactive material, and on its elastic compliance. Compliance in this case is the change of strain with respect to stress or, equivalently, in more practical terms, the change in displacement with respect to force.

The optical element may be deformable from an initial state to a deformed state when a first voltage is applied between the primary electrode(s) and the secondary electrode(s) and may further be deformable to a second deformed state when a second voltage is applied between the primary electrode(s) and the secondary electrode(s). In some embodiments, the deformation response may include a mechanical response to the electrical input that varies over the spatial extent of the device, with the electrical input being applied between the primary electrode(s) and the secondary electrode(s). The mechanical response may be termed an actuation, and example devices or optical elements may be, or include, actuators.

In certain embodiments, an actuator may be located within the transparent aperture of an optical device such as a liquid lens, although the present disclosure is not particularly limited and may be applied in a broader context. By way of example, the optical element may be incorporated into an active grating, tunable lens, accommodative optical element, adaptive optics, etc. According to various embodiments, the optical element may be optically transparent.

As used herein, a material or element that is “transparent” or “optically transparent” may, for example, have a transmissivity within the visible light spectrum of at least approximately 70%, e.g., approximately 70, 80, 90, 95, 97, 98, 99, or 99.5%, including ranges between any of the foregoing values, and less than approximately 10% bulk haze, e.g., approximately 0.1, 0.2, 0.5, 1, 2, 4, 6, or 8% bulk haze, including ranges between any of the foregoing values. In accordance with some embodiments, a “fully transparent” material or element may have a transmissivity (i.e., optical transmittance) within the visible light spectrum of at least approximately 90%, e.g., approximately 90, 95, 97, 98, 99, or 99.5%, including ranges between any of the foregoing values, less than approximately 10% bulk haze, e.g., approximately 0.1, 0.2, 0.5, 1, 2, 4, 6, or 8% bulk haze, including ranges between any of the foregoing values, less than approximately 30% reflectivity, e.g., approximately 1, 2, 5, 10, 15, 20, or 25% reflectivity, including ranges between any of the foregoing values, and at least 70% optical clarity, e.g., approximately 70, 80, 90, 95, 97, 98, 99, or 99.5% optical clarity, including ranges between any of the foregoing values. Transparent and fully transparent materials will typically exhibit very low optical absorption and minimal optical scattering.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

According to various embodiments, the electroactive layers may include a transparent polymer or ceramic material and the electrodes may each include one or more layers of any suitable conductive material, such as transparent conductive oxides (e.g., TCOs such as ITO), graphene, etc.

Example polymer materials forming electroactive polymers may include, without limitation, styrenes, polyesters, polycarbonates, epoxies and/or halogenated polymers. Additional example electroactive polymer materials may include silicone-based polymers, such as poly(dimethyl siloxane), and acrylic polymers, such as ethyl acrylate, butyl acrylate, octyl acrylate, ethoxyethoxy ethyl acrylate, chloromethyl acrylate, methacrylic acid, dimethacrylate oligomers, allyl glycidyl ether, fluorinated acrylates, cyanoacrylate or N-methylol acrylamide. Still further example electroactive polymer materials may include polyvinylidene fluoride (PVDF) or its co-polymers such as polyvinylidene fluoride-trifluoroethylene (PVDF-TrFE), ter-polymers such as polyvinylidene fluoride-trifluoroethylene-chlorofluoroethylene (PVDF-TrFE-CFE), silicone acrylate polymers, and urethane polymers, as well as mixtures of any of the foregoing.

According to some embodiments, the electroactive polymer layer may be formed by depositing a polymer precursor composition containing a curable material, e.g., onto a substrate, and curing the polymer precursor to form a polymer matrix. The polymer precursor composition may be, or include, a liquid. In addition to the curable material, the polymer precursor composition may include one or more of a polymerization initiator, surfactant, emulsifier, and/or other additive(s) such as cross-linking agents. In some embodiments, various components of the polymer precursor composition may be combined into a single mixture and deposited simultaneously. Alternatively, the various components may be deposited individually (i.e., in succession), or in any suitable combination(s).

An anisotropic polymer thin film may be formed using a thin film orientation system configured to heat and stretch a polymer thin film in at least one in-plane direction in one or more distinct regions thereof. In some embodiments, a thin film orientation system may be configured to stretch a polymer thin film along only one in-plane direction.

According to further embodiments, an electroactive ceramic layer may include a transparent polycrystalline ceramic or a transparent single crystal material. In some embodiments, a polycrystalline electroactive ceramic may have a relative density of at least approximately 99%, e.g., 99%, 99.5%, 99.9%, 99.95%, 99.99%, 99.995%, or 99.999%, including ranges between any of the foregoing values, and an average grain size of at least approximately 300 nm, e.g., 300 nm, 400 nm, 500 nm, 1000 nm, or 2000 nm, including ranges between any of the foregoing values.

Example electroactive ceramics may include one or more ferroelectric ceramics, as well as solid solutions or mixtures thereof. Typically, ferroelectric materials are characterized by high dielectric permittivity values, where the temperature of the maximum real dielectric permittivity corresponds to the ferroelectric-paraelectric phase transition temperature. The so-called relaxor ferroelectrics, on the other hand, may exhibit a more elaborate dielectric response. Relaxor ferroelectrics may be characterized by (i) wide peaks in the temperature dependence of the dielectric permittivity, (ii) a frequency-dependent dielectric permittivity, where the temperature of the respective maxima for the real and imaginary components of the permittivity appear at different values, and (iii) a temperature of the maximum in the real dielectric permittivity that may be independent of the ferroelectric-paraelectric phase transition temperature.

The origin of relaxor behavior in ferroelectrics may be attributed to a positional disorder of cations on A or B sites of the perovskite blocks that delay the evolution of long-range polar ordering. Commonly, the localized disorder in relaxor compounds may be attributed to their complex and disordered chemical structure, where multiple atoms may substitute on one atomic site. In the example of lead magnesium niobium oxide, for instance, both magnesium and niobium can occupy the same position in the crystal lattice. As a further example, lead zirconate titanate (PZT) is a typical ferroelectric perovskite showing a conventional FE-PE phase transition. However, the partial substitution of different elements, such as lanthanum or samarium, may increase disorder within the material and induce relaxor characteristics. Moreover, in accordance with some embodiments, for some lanthanum or samarium concentrations, the distortion of the PZT crystalline lattice due to ion displacement may promote the formation of polar nanoregions (PNRs), which may inhibit the formation of long-range ferroelectric domains. For some compositions, polar nanoregions that are present under zero applied field may beneficially persist through an applied field of at least 2 V/micrometer, e.g., at least 0.5, 1, 1.5, or 2 V/micrometer, including ranges between any of the foregoing values, whereas other compositions having polar nanoregions under zero applied field (e.g., PLZT) may undergo a field-induced relaxor-to-ferroelectric phase transformation, which may adversely impact one or more optical properties.

In accordance with various embodiments, example electroactive ceramics may include one or more compositions from the relaxor-PT-based family, which includes binary compositions such as Pb(Mg_{1/3}Nb_{2/3})O₃—PbTiO₃ (PMN-PT), Pb(Zn_{1/3}Nb_{2/3})O₃—PbTiO₃ (PZN-PT), ternary crystals such as Pb(Zn_{1/3}Nb_{2/3})O₃—PbTiO₃—BaTiO₃ (PZN-PT-BT), and the like. Generally, lead-based relaxor materials may be represented by the formula Pb(B1B2)O₃, where B1 may include Mg²⁺, Zn²⁺, Ni²⁺, Sc³⁺, Fe³⁺, Yb³⁺, In³⁺, etc. and B2 may include Nb⁵⁺, Ta⁵⁺, W⁶⁺, etc., although other relaxor compositions are contemplated.

Further electroactive ceramic compositions include barium titanate, barium titanium zirconium oxide, barium titanium tin oxide, barium strontium titanium oxide, barium zirconium oxide, lead magnesium titanium oxide, lead magnesium niobium oxide, lead magnesium niobium titanium zirconium oxide, lead scandium niobium oxide, lead scandium tantalum oxide, lead iron niobium oxide, lead iron tantalum oxide, lead iron tungsten oxide, lead indium niobium oxide, lead indium tantalum oxide, lead lanthanum zirconium titanium oxide, lead ytterbium niobium oxide, lead ytterbium tantalum oxide, lead zinc tantalum oxide, lead zinc niobium oxide, lead zinc niobium titanium oxide, lead zinc niobium titanium zirconium oxide, bismuth magnesium niobium oxide, bismuth magnesium tantalum oxide, bismuth zinc niobium oxide, bismuth zinc tantalum oxide, potassium sodium niobate, and combinations thereof.

Electroactive materials, including polycrystalline ceramics, may be formed by powder processing. Densely-packed networks of high purity, ultrafine polycrystalline particles can be highly transparent and may be more mechanically robust in thin layers than their single crystal counterparts. For instance, optical grade PLZT having >99.9% purity may be formed using sub-micron (e.g., <2 μm) particles. Substitution via doping of Pb²⁺ at A- and B-site vacancies with La²⁺ and/or Ba²⁺ may be used to increase the transparency of perovskite ceramics such as textured or un-textured PLZT, PZN-PT and PMN-PT.

As known to those skilled in the art, ultrafine particle precursors can be fabricated via wet chemical methods, such as chemical co-precipitation, sol-gel and gel combustion. Grinding, ball milling, planetary milling, etc. may be used to modify the size and/or shape of ceramic powders. Green bodies may be formed using tape casting, slip casting, or gel casting. High pressure and high temperature sintering via techniques such as conventional sintering, cold sintering, hot pressing, high pressure (HP) and hot isostatic pressure, spark plasma sintering, flash sintering, two-stage sintering, and microwave sintering, for example, may be used to improve the ceramic particle packing density. More than one of the previous techniques may be used in conjunction as understood by one skilled in the art, for example, to achieve initial densification by one process and final densification by a secondary process while controlling grain growth during sintering. Sintered ceramics may be cut to a desired final shape and thinning via lapping and/or polishing may be used to decrease surface roughness to achieve thin, highly optically transparent layers that are suitable for high displacement actuation.

In addition to the foregoing, single crystal ceramics may be formed, for example, using hydrothermal processing or by a Czochralski method to produce an oriented ingot, which may be cut along a specified crystal plane to produce wafers having a desired crystalline orientation. Further methods for forming single crystals include float zone, Bridgman, Stockbarger, chemical vapor deposition, physical vapor transport, solvothermal techniques, etc. A wafer may be thinned, e.g., via lapping or grinding, and/or polished, and transparent electrodes (e.g., a primary electrode and a secondary electrode) may be formed directly on the wafer, using chemical vapor deposition or a physical vapor deposition process such as sputtering or evaporation, for example. According to some embodiments, an electroactive ceramic layer may have an RMS surface roughness of less than approximately 50 nm, e.g., less than 50, 40, 30, 20, 10, or 5 nm, including ranges between any of the foregoing values. The electroactive ceramic may be poled to achieve a desired dipole alignment.

In certain embodiments, the electroactive ceramics disclosed herein may be substantially free of secondary phases, i.e., may contain less than approximately 1% by volume of any secondary phase, including porosity, e.g., less than 1%, less than 0.5%, less than 0.2%, less than 0.1%, less than 0.05%, less than 0.02%, less than 0.01%, less than 0.005%, less than 0.002%, or less than 0.001% by volume, including ranges between any of the foregoing values. In some embodiments, the disclosed electroactive ceramics may be birefringent, which may be attributable to the material having plural distinct domains (e.g., polar nanoregions) or regions of varying polarization having different refractive indices.

According to various embodiments, a relaxor ceramic may include discrete (localized) regions of polar, i.e., non-cubic, material in a matrix having cubic symmetry. According to some embodiments, the polar nanoregions may have at least one dimension (length, width, or depth) of less than approximately 100 nm, e.g., less than 100 nm, less than 50 nm, less than 40 nm, less than 30 nm, less than 20 nm, less than 10 nm, or less than 5 nm, including ranges between any of the foregoing values. Electroactive (relaxor) ceramics may, according to some embodiments, be characterized by cubic or pseudo-cubic symmetry.

In some embodiments, optical elements may include paired electrodes, which allow the creation of the electrostatic field that forces displacement of an intervening electroactive layer. In some embodiments, an “electrode,” as used herein, may refer to an electrically conductive material, which may be in the form of thin film, layer, a grid, mesh, and/or any other suitable patterned layer or combination of layers. Electrodes may include relatively thin, electrically conductive metals or metal alloys and may be of a non-compliant or compliant nature.

An electrode may include one or more electrically conductive materials, such as a metal, a semiconductor (e.g., a doped semiconductor), carbon nanotubes, graphene, oxidized graphene, fluorinated graphene, hydrogenated graphene, other graphene derivatives, carbon black, transparent conductive oxides (TCOs, e.g., indium tin oxide (ITO), zinc oxide (ZnO), etc.), conducting polymers (e.g., PEDOT), or other electrically conducting materials. In some embodiments, the electrodes may include a metal such as aluminum, gold, silver, platinum, palladium, nickel, tantalum, tin, copper, indium, gallium, zinc, alloys thereof, and the like. Further example transparent conductive oxides include, without limitation, aluminum-doped zinc oxide, fluorine-doped tin oxide, indium-doped cadmium oxide, indium zinc oxide, indium zinc tin oxide, indium gallium tin oxide, indium gallium zinc oxide (IGZO), indium gallium zinc tin oxide, strontium vanadate, strontium niobate, strontium molybdate, and calcium molybdate.

Example electrodes may have a sheet resistance of less than approximately 5000 ohms/square. In some embodiments, the electrode or electrode layer may be self-healing, such that damage from local shorting of a circuit can be isolated. Suitable self-healing electrodes may include thin films of materials that deform or oxidize irreversibly upon Joule heating, such as, for example, aluminum.

In some embodiments, a primary electrode may overlap (e.g., overlap in a parallel direction) at least a portion of a secondary electrode. The primary and secondary electrodes may be generally parallel and spaced apart and separated by a layer of electroactive material. A tertiary electrode may overlap at least a portion of either the primary or secondary electrode.

An optical element having stacked electroactive layers may include, for example, a first electroactive layer, which may be disposed between a first pair of electrodes (e.g., the primary electrode and the secondary electrode). A second electroactive layer may be located adjacent to the optical element and may be disposed between a second pair of electrodes. In some embodiments, there may be an electrode that is common to both the first pair of electrodes and the second pair of electrodes.

In some embodiments, one or more electrodes may be optionally electrically interconnected, e.g., through a contact or schoopage layer, to a common electrode. In some embodiments, an optical element may have a first common electrode, connected to a first plurality of electrodes, and a second common electrode, connected to a second plurality of electrodes. In some embodiments, electrodes (e.g., one of a first plurality of electrodes and one of a second plurality of electrodes) may be electrically isolated from each other using an insulator, such as a dielectric layer. An insulator may include a material without appreciable electrical conductivity, and may include a dielectric material, such as, for example, transparent aluminum, an acrylate, or a silicone polymer.

In some applications, a transparent electroactive actuator used in connection with the principles disclosed herein may include a primary electrode, a secondary electrode, and an electroactive layer disposed between the primary electrode and the secondary electrode. In some embodiments, there may be one or more additional electrodes, and a common electrode may be electrically coupled to one or more of the additional electrodes. For example, a pair of actuators may be disposed in a stacked configuration, with a first common electrode coupled to a first plurality of electrodes, and a second common electrode electrically connected to a second plurality of electrodes. In some embodiments, a common electrode may be electrically coupled (e.g., electrically contacted at an interface having a low contact resistance) to one or more other electrode(s), e.g., a secondary electrode and a tertiary electrode located on either side of a primary electrode.

In some embodiments, electrodes may be flexible and/or resilient and may stretch, for example elastically, when an optical element undergoes deformation. In this regard, electrodes may include a metal such as aluminum, graphene, carbon nanotubes, nanowires, etc. In other embodiments, relatively rigid electrodes (e.g., electrodes including one or more transparent conducting oxides (TCOs) such as indium tin oxide (ITO) or indium gallium zinc oxide (IGZO)) may be used.

In some embodiments, the electrodes (e.g., the primary electrode and the secondary electrode) may have a thickness of approximately 0.35 nm to approximately 1000 nm, e.g., approximately 0.35, 0.5, 1, 2, 5, 10, 20, 50, 100, 200, 500, or 1000 nm, including ranges between any of the foregoing values, with an example thickness of approximately 10 nm to approximately 50 nm. In some embodiments, a common electrode may have a sloped shape, or may be a more complex shape (e.g., patterned or freeform). In some embodiments, a common electrode may be shaped to allow compression and expansion of an optical element or device during operation.

The electrodes in certain embodiments may have an optical transmissivity of at least approximately 50%, e.g., approximately 50%, approximately 60%, approximately 70%, approximately 80%, approximately 90%, approximately 95%, approximately 97%, approximately 98%, approximately 99%, or approximately 99.5%, including ranges between any of the foregoing values.

In some embodiments, the electrodes described herein (e.g., the primary electrode, the secondary electrode, or any other electrode including any common electrode) may be fabricated using any suitable process. For example, the electrodes may be fabricated using physical vapor deposition (PVD), chemical vapor deposition (CVD), atomic layer deposition (ALD), evaporation, spray-coating, spin-coating, dip-coating, screen printing, Gravure printing, ink jet printing, aerosol jet printing, doctor blading, and the like. In further aspects, the electrodes may be manufactured using a thermal evaporator, a sputtering system, stamping, etc.

In some embodiments, a layer of electroactive material may be deposited directly on to an electrode. In some embodiments, an electrode may be deposited directly on to the electroactive material. In some embodiments, electrodes may be prefabricated and attached to an electroactive material. For instance, a prefabricated electrode may be bonded to an electroactive layer by thermocompression, metallic bonding, or other wafer bonding technology, or by using an adhesive layer such as a pressure sensitive adhesive. Example pressure sensitive adhesives include various acrylate compounds. In further embodiments, an electrode may be deposited on a substrate, for example a glass substrate or flexible polymer film. In some embodiments, the electroactive material layer may directly abut an electrode. In some embodiments, there may be an insulating layer, such as a dielectric layer, between a portion of a layer of electroactive material and an electrode.

The electrodes may be used to affect large scale deformation, i.e., via full-area coverage, or the electrodes may be patterned to provide spatially localized stress/strain profiles. In particular embodiments, a deformable optical element and an electroactive layer may be co-integrated whereby the deformable optical element may itself be actuatable. In addition, various methods of forming optical elements are disclosed, including solution-based and solid-state deposition techniques.

For electroactive materials, particularly single crystal and polycrystalline piezoelectrics, optical absorption is characteristically low and transmissive losses are typically dominated by reflectivity. Moreover, piezoceramics and single crystal electroactive compositions typically have high refractive indices, which can substantially mismatch neighboring media resulting in surface reflections. Summarized in Table 1 are example materials that may be used for the electroactive layers, electrodes, passive support, as well as application specific layers.

TABLE 1
Example Actuator Materials

| | Material | Refractive Index |
|---|---|---|
| Electroactive Layers | PVDF | 1.42 |
| | PMN-PT | 2.4-2.6 |
| | PZT | 2.4 |
| Electrodes | ITO | ~1.9 |
| Passive Support | Plastic | 1.4-1.6 |
| | Glass | 1.4-1.9 |
| | Sapphire | 1.7-1.8 |
| Liquid Lens Fluid | Polyphenyl ether (PPE) | 1.58 |
| | Phenylated siloxane oil | 1.62 |

In order to mediate reflective losses and inhibit the creation of optical artifacts such as ghost images, example actuator structures may further include a reflective or antireflective coating (ARC). According to various embodiments, a reflective or antireflective coating may be disposed over either or both electrodes (e.g., a primary antireflective coating may be formed over at least a portion of a surface of the primary electrode opposite to the electroactive layer and/or a secondary reflective or antireflective coating may be formed over at least a portion of a surface of the secondary electrode opposite to the electroactive layer).

The antireflective coating(s) may be optically transparent and accordingly exhibit less than 10% bulk haze and a transmissivity within the visible spectrum of at least 70%. For instance, an antireflective coating may be configured to maintain at least 70% transmissivity over 106 actuation cycles and an induced engineering strain of up to approximately 1%. In some embodiments, the antireflective coating(s) may exhibit a reflectivity within the visible spectrum of less than approximately 30%.

Example antireflective coatings may include one or more dielectric layers, which may include a stoichiometric or non-stoichiometric oxide, fluoride, oxyfluoride, nitride, oxynitride, sulfide, including but not limited to SiO₂, TiO₂, Al₂O₃, Y₂O₃, HfO₂, ZrO₂, Ta₂O₅, Cr₂O₃, AlF₃, MgF₂, NdF₃, LaF₃, YF₃, CeF₃, YbF₃, Si₃N₄, ZnS, or ZnSe.

In some embodiments, an antireflective coating may be configured as a multilayer stack. A multilayer stack may include one or more dielectric layers, and in certain embodiments an antireflective coating may include a transparent electrode. That is, a primary electrode or a secondary electrode may be integrated into a multilayer antireflective coating.

In some embodiments, the anti-reflective coating may include combinations of one or more of the aforementioned oxides and/or one or more of the aforementioned fluorides. In accordance with some embodiments, an antireflective coating may operate to gradually decrease the refractive index between that of the electroactive layer and an adjacent, typically lower index material. In various embodiments, an antireflective coating may include multiple layers of varying refractive index and/or one or more layers having a refractive index gradient.

An ARC layer may have any suitable thickness, including, for example, a thickness of approximately 10 nm to approximately 1000 nm, e.g., approximately 10, 20, 50, 100, 200, 500, or 1000 nm, including ranges between any of the foregoing values, with an example thickness range of approximately 50 nm to approximately 100 nm.

In various embodiments, the one or more layers within an antireflective coating may be fabricated using any suitable process. For example, the ARC layer(s) may be fabricated using physical vapor deposition (PVD), chemical vapor deposition (CVD), atomic layer deposition (ALD), evaporation, spray-coating, spin-coating, dip-coating, screen printing, Gravure printing, ink jet printing, aerosol jet printing, doctor blading, and the like.

In some embodiments, a multilayer actuator stack may include a barrier layer. A suitable barrier layer may operate as a functional coating adapted to decrease the transmittance therethrough of light and/or the transpiration therethrough of water, water vapor, or other liquids or gases. In certain embodiments, a barrier layer may be configured to inhibit the permeation of water vapor to less than approximately 10⁻⁶ g/m²/day and/or inhibit the permeation of oxygen to less than approximately 10⁻⁵ cm³/m²/day. According to further embodiments, a barrier layer may improve the mechanical robustness of a multilayer actuator, e.g., via crack blunting and/or vibration reduction. A barrier layer may be colorless, chemically inert, electrically insulating, and/or scratch resistant and may include various epoxy compounds. In some embodiments, an antireflective coating, e.g., one or more layers within a multilayer antireflective coating, may serve as a barrier layer.

A bonding layer, such as an optical adhesive, may be used to join adjacent layers within a multilayer structure. According to some embodiments, a bonding layer may include a pressure-sensitive adhesive (PSA) such as one or more acrylate-based polymers derived from soft monomers (i.e., low Tg monomers for tack and flexibility), hard monomers (i.e., high Tg monomers for cohesion strength) and functional monomers (e.g., for adhesion strength). Example PSA materials include 2-ethylhexyl acrylate (2-EHA), methyl methacrylate (MMA), butylacrylate, hexylacrylate, isooctylacrylate, 2-hydroxyethyl acrylate (2-HEA), lauryl acrylate (LA), acrylic acid (AA), 2-phenoxy ethyl acrylate (2-PEA), etc. In some embodiments, such acrylates may be functionalized with a cross linking agent, such as aluminum acetylacetonate (AlAcAc), zirconium acetylacetonate (ZrAcAc), hafnium carboxyethyl acrylate (HCA), and the like.

In some embodiments, the barrier layer and/or the bonding layer may include a double network tough adhesive (DNTA). A DNTA, which may be colorless and optically clear, may include a high-performance PSA with acid and epoxy functionalities combined with an acrylated urethane oligomer, a methacrylated silane thermoset cross-linker, and/or a photo-initiator (e.g., a metal chelate ionic cross-linker). A barrier layer and/or bonding layer, if provided, may be indexed-matched with the electroactive layer(s) to decrease internal reflection amongst the plural layers of a multilayer actuator.

In accordance with certain embodiments, an optical element such as an actuator may include a substrate, such as a passive support, which may include a glass, ceramic, polymer or other dielectric composition. An example passive support may include sapphire. A passive support may influence the mechanical performance of the actuator including its stiffness and buckling response. In some embodiments, the support may include a planar, meniscus, or ophthalmic glass substrate. In some embodiments, a bonding layer may be used to affix the passive support to the actuator architecture.

In accordance with certain embodiments, a transparent actuator including an electroactive layer disposed between transparent electrodes may be incorporated into a variety of device architectures where capacitive actuation and the attendant strain realized in the electroactive layer (e.g., lateral expansion and compression in the direction of the applied electric field) may induce deformation in one or more adjacent active layers within the device and accordingly change the optical performance of the active layer(s). Lateral deformation may be essentially 1-dimensional, in the case of an anchored thin film, or 2-dimensional.

Insomuch as many piezoelectric ceramics and single crystals are limited to less than approximately 0.1% to approximately 2% strain before failure, electroactive actuators are commonly operated in a bending mode to achieve large displacements albeit with a compromise in force output. In an example bimorph bending mode actuator, alternating tensile and compressive stresses above and below a neutral plane may be used to generate bending motion. As such, multilayer structures with one or more electroactive layers may be used to achieve a desired stress (and strain) condition.

In certain applications, such as a liquid lens, where a high net displacement over a large surface area may be beneficial, the onset of buckling instabilities may decrease the accessible actuation range for some multilayer actuator geometries. Buckling may occur when a structure is loaded above a critical compressive stress, which for a transparent actuator is related to the stress induced via the indirect piezoelectric effect. According to some embodiments, however, the usable actuation range otherwise limited by a buckling instability may be improved through appropriate mechanical design, e.g., to increase the critical compressive stress of the electroactive layer(s).

In some embodiments, an optical device may include a fluid lens, such as a liquid lens. As will be appreciated, in accordance with various embodiments, a liquid lens fitted with a multilayer actuator may provide varifocal accommodation with high see-through quality and effective actuation within a commercially-relevant form factor. That is, a liquid lens having a transparent multilayer actuator functioning as a deformable surface is an attractive solution to meet space constraints.

According to various embodiments, a multilayer actuator may include alternating electrode and electroactive material layers. The application of a voltage between respective electrode pairs can cause compression or expansion of the intervening electroactive layer in the direction of the applied electric field and an associated expansion or contraction of the electroactive layer in one or more transverse dimensions. In some embodiments, an applied voltage (e.g., to the primary electrode and/or the secondary electrode) may create at least approximately 0.02% strain in an electroactive layer (e.g., an amount of deformation in the direction of the applied force resulting from the applied voltage divided by the initial dimension of the material) in at least one direction (e.g., an x, y, or z direction with respect to a defined coordinate system).

An electrical signal may include a potential difference, which may include a direct or alternating voltage. In some embodiments, the frequency may be higher than the highest mechanical response frequency of the device, so that deformation may occur in response to the applied RMS electric field but with no appreciable oscillatory mechanical response to the applied frequency. The applied electrical signal may generate nonuniform constriction of the electroactive layers between the respective primary and secondary electrodes. A nonuniform electroactive response may include a curvature of a surface of the optical element, which may in some embodiments be a compound curvature.

In some embodiments, an optical device may include additional elements interleaved between electrodes, such as in a stacked configuration. For example, electrodes may form an interdigitated stack of electrodes, with alternate electrodes connected to a first common electrode and the remaining alternate electrodes connected to a second common electrode. An additional optical element may be disposed on the other side of a primary electrode. The additional optical element may overlap a first optical element. An additional electrode may be disposed abutting a surface of any additional optical element.

Aspects of the present disclosure relate to an actuator that may be configured to overlie and provide controllable deformation to an optical element such as a liquid lens. In particular embodiments, the actuator membrane (i.e., the active membrane) can be used to independently control both a spherical and a cylindrical profile of the lens, including the creation of a variable cylinder radius and axis.

An example actuator may include an architecture of one or more layers of an oriented electro-mechanical material. Each layer may be individually electroded and independently oriented in-plane where, for example, a difference in the inter-layer orientation of successive layers in a composite (stacked) architecture may be at least approximately 10°. An applied bias and the attendant actuation and strain response in one or more of the layers may provide a cumulative deformation of the actuator and a desired induced optical power in the lens.

The plural layers may include uniaxially-oriented piezoelectric or electrostrictive polymers such as PVDF and its co-polymers, or a variety of suitable uniaxially-oriented piezoelectric ceramics such as PMN-PT. Further example electro-mechanical materials may include uniaxially-oriented electroactive polymers. In certain embodiments, the multilayer actuator may be optically transparent. An optical adhesive, which may include a refractive index-matching material, may be used to bond the layers together.

Features from any of the embodiments described herein may be used in combination with one another in accordance with the general principles described herein. These and other embodiments, features, and advantages will be more fully understood upon reading the following detailed description in conjunction with the accompanying drawings and claims.

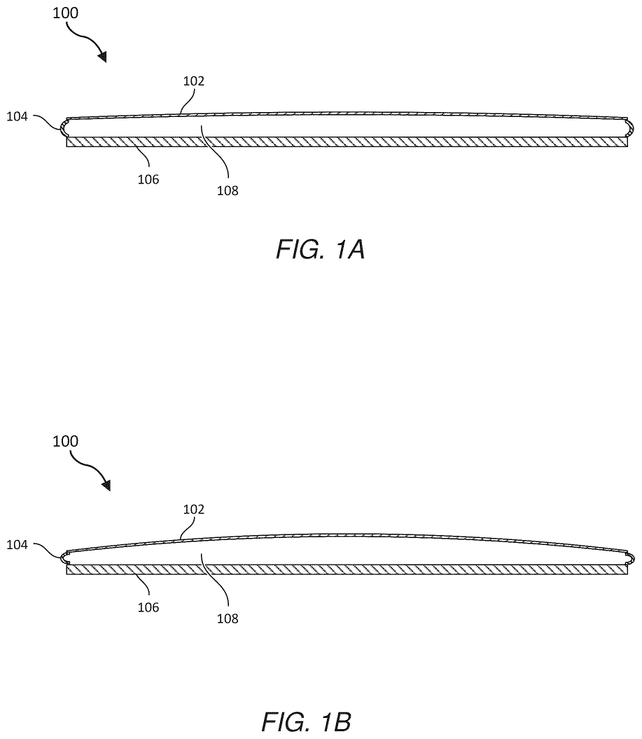

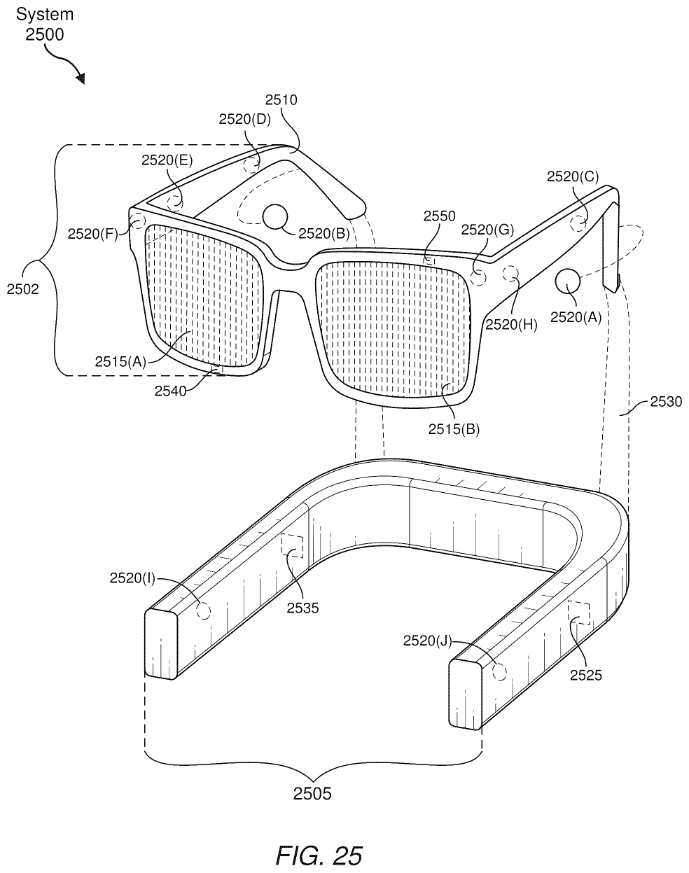

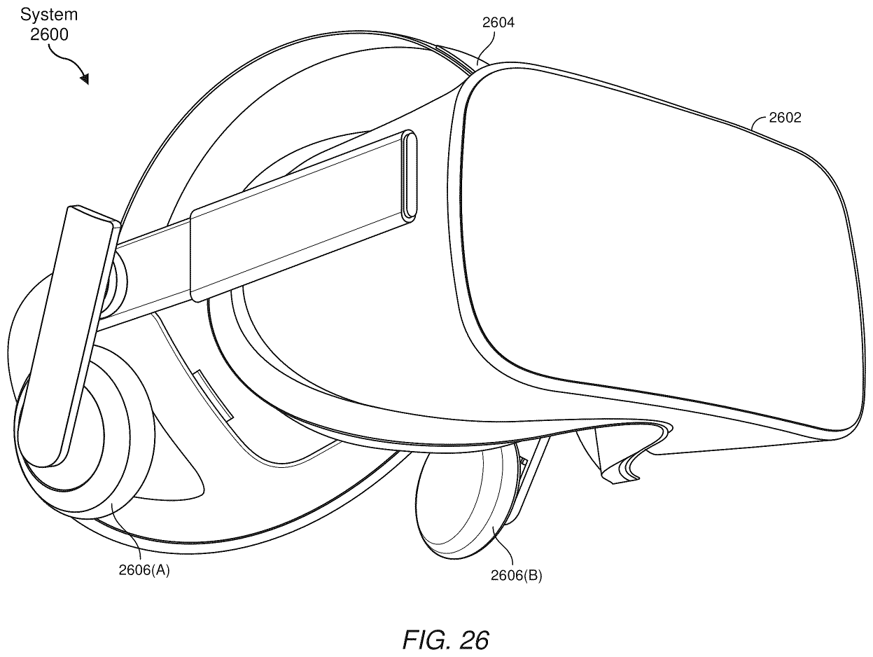

The following will provide, with reference to FIGS. 1-26, a detailed description of fluid lenses including actuators and peripheral spring members suitable for forming spherical curvature in an actuated state with minimal optical error in both unactuated and actuated states. The discussion associated with FIGS. 1-24 relates to the architecture, operation, and manufacturing of various example fluid lenses and spring members. The discussion associated with FIGS. 25 and 26 relates to exemplary virtual reality and augmented reality devices that may include a fluid lens as disclosed herein.

An example fluid lens is illustrated in FIGS. 1A and 1B. Liquid lens 100 shown in these figures may be configured for one or more artificial reality applications, and may include an electromechanical actuator 102, a spring member 104 located between electromechanical actuator 102 and a support 106 (e.g., a passive support or substrate), and a lens fluid 108 disposed between electromechanical actuator 102 and support 106 and contained by spring member 104. An example spring member 104 may include polyurethane, silicone rubber, metal, and/or any other suitable resilient material. According to various examples, lens fluid 108 may include a liquid, such as a silicone and/or oil composition having a desired refractive index and viscosity. In some examples, lens fluid 108 may include one or more polymers (e.g., polyphenyl thioethers) and/or other suitable additives. In the illustrated liquid lens 100, electromechanical actuator 102 may directly overly lens fluid 108 and, in an unactuated state, may have an outward-facing convex profile (as illustrated) or an outward-facing concave profile. In various embodiments, spring member 104 may bow outward so as to have an outward-facing convex cross-sectional profile as illustrated in FIGS. 1A and 1B.

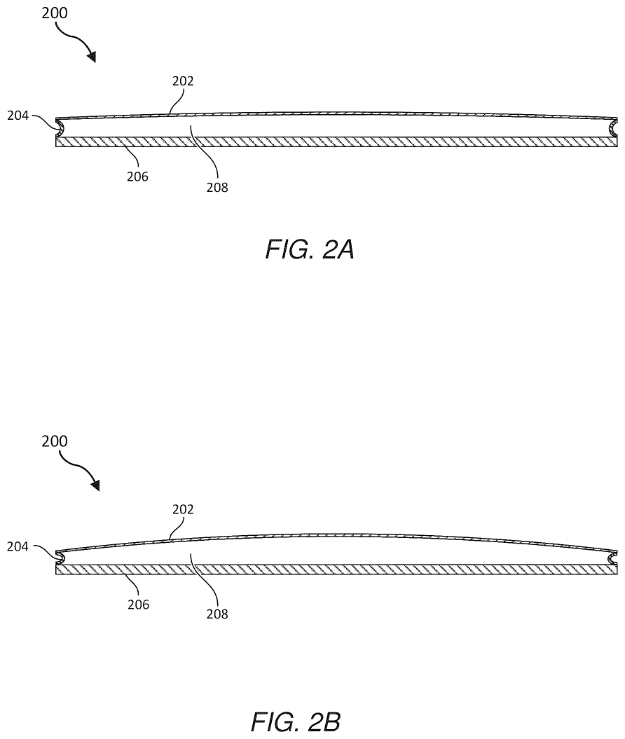

In some embodiments, spring member 104, or at least a portion of spring member 104, may bow inward so as to have an outward-facing concave cross-sectional profile (see, e.g., FIGS. 2A and 2B). At least a portion of spring member 104 may be configured to deform during actuation of electromechanical actuator 102. For example, a bowed or bent portion of spring member 104 may be compressed between electromechanical actuator 102 and support 106 when electric field is applied to electromechanical actuator 102.

FIGS. 1A and 1B respectively illustrate liquid lens 100 in different states forming distinct lens shapes via electromechanical actuator 102. In one example, FIG. 1A shows liquid lens 100 in a first (e.g., an unactuated or partially actuated state). In this first state, a first voltage differential may be applied between paired electrodes of electromechanical actuator 102 (this voltage differential may be zero in various examples). Electromechanical actuator 102, which may act as a membrane defining and modifying an optical surface shape of liquid lens 100, may have a relatively low amount of curvature while in the first state.

FIG. 1B shows liquid lens 100 in a second state having a greater degree of lens curvature. In the second state, a second voltage differential (e.g., a greater differential) may be applied between the paired electrodes of electromechanical actuator 102. The electric field generated by the voltage differential may cause electromechanical actuator 102 to assume an increased degree of curvature, particularly over more centrally located regions of liquid lens 100. As the curvature is increased by electromechanical actuator 102, at least a portion of spring member 104 may be compressed between peripheral portions of electromechanical actuator 102 and support 106. In some examples, as spring member 104 is compressed, portions of spring member 104 may be forced laterally outward as they are bent or further curved during deformation of electromechanical actuator 102.

An amount of deformation exhibited at various portions of spring member 104 during actuation of electromechanical actuator 102 may depend on a number of factors. These factors may include, for example, the material[s] forming spring member 104, as well as the shape, thickness, and height of spring member 104 between electromechanical actuator 102 and support 106. Additionally, characteristics of electromechanical actuator 102 and lens fluid 108 may influence the deformation of spring member 104. For example, deformation of spring member 104 may be affected by the materials, shape, layer thickness, number of layers, actuation force, and degree of curvature of electromechanical actuator 102. An amount of overlap between electromechanical actuator 102 and abutting portions of spring member 104 may also affect the deformation of spring member 104. In various examples, the composition of lens fluid 108 as well as the volume and height of lens fluid 108 between electromechanical actuator 102 and support 106 may influence the deformation of spring member 104. Deformation exhibited by portions of spring member 104 may also be affected by various other factors.

FIGS. 2A and 2B show a liquid lens 200 in accordance with some embodiments, as shown in these figures, liquid lens 200 may include an electromechanical actuator 202, a spring member 204 located between electromechanical actuator 202 and a support 206 (i.e., a substrate), and a lens fluid 208 disposed between electromechanical actuator 202 and support 206. In this example, spring member 204 may bow inward towards a central region of liquid lens 200. In some examples, as spring member 204 is compressed, portions of spring member 204 may be forced laterally inward as they are bent or further curved during deformation of electromechanical actuator 102.

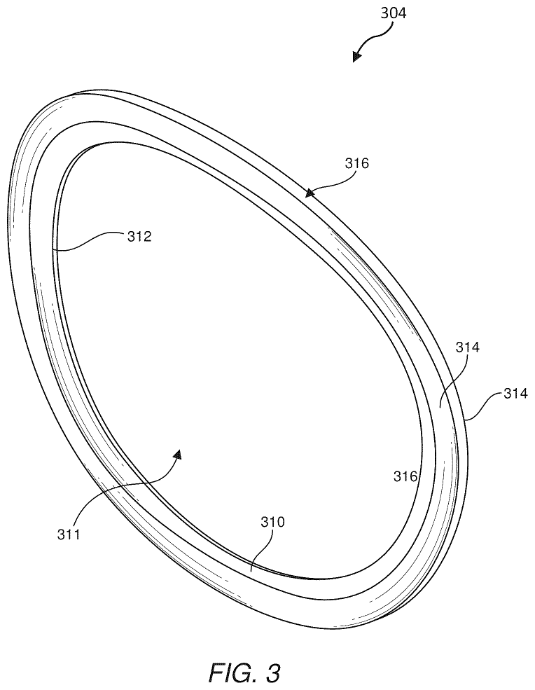

FIG. 3 shows a spring member 304 in accordance with some embodiments. Spring member 304 includes a flexure 310 and a pair of mounting surfaces 314. As shown in FIG. 3, spring member 304 may follow a generally annular path peripherally surrounding an inner opening 311. In this example, flexure 310 extends inward towards inner opening 311 (see also FIGS. 2A and 2B). Spring member 304 is configured to surround a lens fluid contained within the inner opening 311 in a liquid lens. In some examples, the lens fluid may contact flexure 310 within the liquid lens.

As shown in FIG. 3, flexure 310 of spring member 304 may substantially surround inner opening 311, which may be configured to accommodate the lens fluid of a liquid lens. Flexure 310 may have any suitable shape configured to support and exert a spring force between an electromechanical actuator and a support of a liquid lens. For example, flexure 310 may include a pair of inwardly sloping surfaces that meet at an apical region 312, which has a bent or generally angular profile. Apical region 312 may generate a substantial portion of a spring force when spring member 304 is compressed between an electromechanical actuator and a support of a liquid lens. While flexure 310 shown in FIG. 3 has inwardly sloping surfaces, in some examples, a flexure may additionally or alternatively include a pair of surfaces that slope peripherally outward and meet at an apical region. In some embodiments, a flexure may have an inwardly or outwardly curving profile having an arcuate cross-sectional profile (see, e.g., FIGS. 1A-2B).

The pair of mounting surfaces 314 may be located at peripheral ends of flexure 310. According to some embodiments, mounting surfaces 314 may be configured to respectively abut facing portions of an electromechanical actuator and a substrate or support member of a liquid lens (see, e.g., electromechanical actuator 202 and support 206 of liquid lens 200 and FIGS. 2A and 2B). Mounting surfaces 314 may be coupled to abutting actuator and support surfaces in any suitable manner. For example, mounting surfaces 314 may be directly bonded to abutting surfaces or they may be coupled to the abutting surfaces via one or more intermediate layers (e.g., an adhesive layer). In various examples, mounting surfaces 314 may be adhered to adjacent surfaces of a liquid lens in a manner that prevents leakage of a lens fluid from within the liquid lens and/or that prevents an interior region of the liquid lens from being exposed to external agents. Accordingly, the volume of lens fluid in a liquid lens may be contained within the liquid lens and may remain relatively constant while in various states of liquid lens actuation. Flexure 310 and mounting surfaces 314 may define a recess 316. In at least one example, as shown in FIG. 3, recess 316 may have an outwardly facing concave shape defined by mounting surfaces 314 and flexure 310.

Spring member 304 may have any shape and size suitable for use in a liquid lens. For example, spring member 304 may have a generally annular shape that corresponds to the shape of an optical lens and/or a frame surrounding a central region (e.g., the viewing area) of the optical lens. In some examples, spring member 304 may have a shape that generally follows the shape of a portion of a glasses frame (e.g., an augmented reality glasses frame) configured to hold the liquid lens. Spring member 304 may be configured to overlap or be held within the frame, with other portions of the liquid lens surrounded by spring member 304 exposed within a lens region surrounded by the frame.

According to various embodiments, spring member 304 may have a nonuniform spring stiffness. More particularly, spring member 304 may vary in spring stiffness between two or more regions proceeding peripherally around inner opening 311. Certain characteristics, such as the shape and/or thickness of flexure 310, may be varied along a path proceeding around inner opening 311, resulting in corresponding variations in stiffness. Any other suitable characteristics of spring member 304 may additionally or alternatively be varied around inner opening 311. In at least one embodiment, the spring stiffness of at least a portion of spring member 304, such as flexure 310, may be selectively varied between different locations so as to guide an active membrane (e.g., electromechanical actuator 102 or 202 shown in FIGS. 1A-2B) of a liquid lens into a spherical or substantially spherical shape, particularly in cases where the liquid lens has a non-circular peripheral profile. Accordingly, spring member 304 may enable production of liquid lenses having a variety of different lens shapes and sizes while allowing for formation of a spherical shape via actuation of the active membrane.

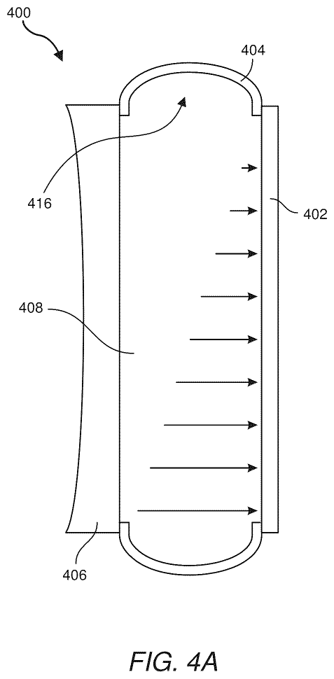

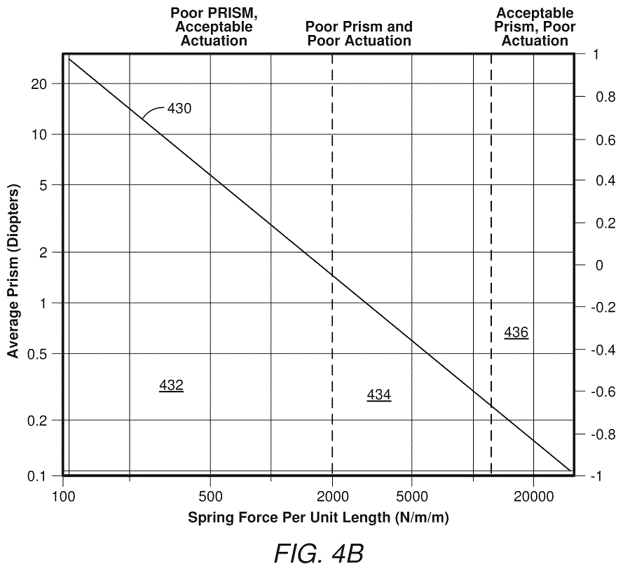

FIG. 4A illustrates differences in pressure within regions of a liquid lens that may produce gravity sag in the liquid lens. In conventional liquid lenses, gravity sag may cause an active membrane of a liquid lens to tilt in conjunction with a pressure gradient caused by the effect of gravity acting on the lens fluid within the lens. FIG. 4A shows an exemplary liquid lens 400 having an active membrane 402 (e.g., electromechanical actuator 102 or 202 in FIGS. 1A-2B), a support 406 facing active membrane 402, and a spring member 404 disposed at least partially between active membrane 402 and support 406. Spring member 404 may define a recess 416. In some examples, support 406 may be shaped to provide a certain degree of optical correction (e.g., support 406 is shown with a concave surface facing away from active membrane 402, which may provide prescriptive correction for a user). A lens fluid 408, such as a suitable lens liquid composition, may be sealed within liquid lens 400, with lens fluid 408 disposed between active membrane 402 and support 406 and peripherally surrounded by spring member 404.

A pressure gradient produced within lens fluid 408 due to the effect of gravity is represented by arrows within lens fluid 408. As indicated by the illustrated arrows, pressure exerted within liquid lens 400 by lens fluid 408 may progressively increase under the influence of gravity, proceeding from an upper region to a lower region of lens fluid 408. Gravity sag may lead to conditions within a liquid lens that create difficulties in providing an acceptable optical prism while also providing acceptable lens actuation having proper characteristics in various lens states. These issues may become more pronounced and may be more difficult to address in larger lenses and lenses having noncircular peripheries.

FIG. 4B is a plot illustrating the effect of gravity sag in various liquid lenses that do not include variable-stiffness spring members, as disclosed herein. Curve 430 of the plot shows average prism versus average spring force per unit of length for liquid lenses having uniform-stiffness peripheral supports. The average prism is an optical error indicator representing a degree of prism distortion, in diopters, of the liquid lens due to gravity sag (see, e.g., FIG. 4A). The spring force represents a uniform spring stiffness of a spring member or other support member coupled to a periphery of the active membrane. The spring force indicates units of force per unit of length around the perimeter of the liquid lens.

As illustrated in FIG. 4B, gravity sag may produce undesirable optical errors in conventional liquid lenses having uniform-stiffness peripheral supports. The gravity sag may make it difficult to produce a lens exhibiting both acceptably low prism distortion and sufficient lens actuation to produce a spherical lens shape, particularly in lenses having a noncircular periphery. Curve 430 illustrates that gravity sag may produce a large amount of prism distortion in lenses having a low spring force. Increasing the spring force at the lens periphery may reduce the prism distortion to an acceptable level, but the required spring force may be so great that proper actuation of the liquid lens is prevented, resulting in a lens shape having insufficient sphere. While liquid lenses having lower spring stiffness within region 432 in FIG. 4B may produce an acceptable amount of lens actuation and sphere, the lenses may exhibit an unacceptable degree of prism distortion, particularly in an unactuated state. Liquid lenses having increased spring stiffness within region 434 may still exhibit an unacceptably high degree of prism distortion while also displaying poor lens actuation. While liquid lenses within region 436 having even higher spring stiffness may exhibit an acceptably low degree of prism distortion, they may nonetheless suffer from poor lens actuation. In contrast, liquid lenses having nonuniform-stiffness spring members, as disclosed herein, can provide both acceptable sphere with minimal cylinder during actuation and an acceptably low amount of prism distortion when not actuated (e.g., a prism diopter of less than approximately 0.25).

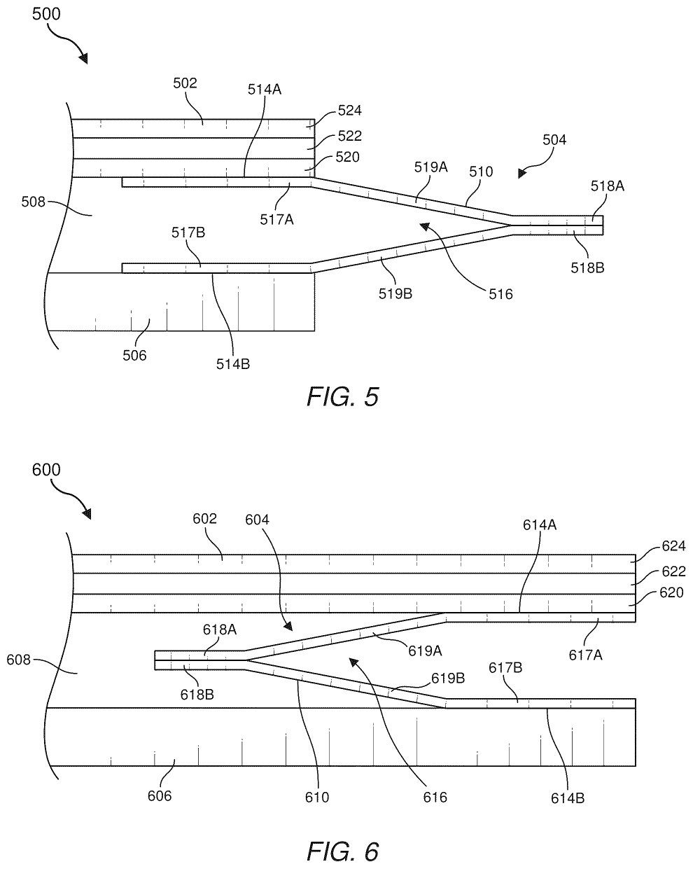

FIGS. 5 and 6 show cross-sectional portions of liquid lenses in accordance with some embodiments. Each of these views represents a view of a cross-section of a liquid lens taken along a plane extending parallel to an optical axis of the lens. In some examples, a spring member of a liquid lens may include multiple segments. For example, liquid lens 500 shown in FIG. 5 includes a spring member 504 having a first spring segment 517A and a second spring segment 517B coupled together at a region between an electromechanical actuator 502 and a support 506 (i.e., a substrate) of liquid lens 500. In some examples, electromechanical actuator 502 may include one or more layers, including one or more electroactive layers. For example, electromechanical actuator 502 may include a plurality of layers, including a first actuator layer 520, a second actuator layer 522, and a third actuator layer 524. According to at least one example, first and third actuator layers 520 and 524 may include electroactive elements, such as piezoelectric and/or electroactive polymer elements, and second actuator layer 522 may be an intermediate layer that includes, e.g., a flexible insulating polymer material.

Spring member 504 extends peripherally outward from electromechanical actuator 502 and support 506 such that a flexure 510 of spring member 504 defines an inwardly facing recess 516 surrounding a portion of a lens fluid 508. First spring segment 517A includes a first mounting surface 514A that abuts electromechanical actuator 502. First spring segment 517A also includes a first flexure portion 519A that extends peripherally outward from first mounting surface 514A, sloping towards a first spring coupling portion 518A. Second spring segment 517B includes a second mounting surface 514B that abuts support 506 and a second flexure portion 519B that extends peripherally outward from second mounting surface 514B, sloping towards a second spring coupling portion 518B.

As shown in FIG. 5, first and second spring coupling portions 518A and 518B are coupled together at a generally apical region of flexure 510. First and second spring segments 517A and 517B may each include any suitable material or combination of materials, such as a resilient polymer and/or metal material configured to deform and exert a spring force against a peripheral portion of electromechanical actuator 502. First and second spring coupling portions 518A and 518B may be coupled together in any suitable manner that prevents leakage of lens fluid 508 and holds the two portions together during deformation of spring member 504. For example, first and second spring coupling portions 518A and 518B may be directly or indirectly bonded, adhered, welded, soldered, mechanically fastened, and/or otherwise attached to each other.

Liquid lens 600 shown in FIG. 6 includes a spring member 604 having a first spring segment 617A and a second spring segment 617B coupled together at a region between an electromechanical actuator 602 and a support 606 (i.e., a substrate) of liquid lens 600. Electromechanical actuator 602 may include a plurality of layers, including a first actuator layer 620, a second actuator layer 622, and a third actuator layer 624. Spring member 604 extends peripherally inward toward lens fluid 608 such that a flexure 610 of spring member 604 defines an outwardly facing recess 616. First spring segment 617A includes a first mounting surface 614A that abuts electromechanical actuator 602 and a first flexure portion 619A that extends inward towards a central region of liquid lens 600. First flexure portion 619A may extend from first mounting surface 614A, sloping towards a first spring coupling portion 618A. Second spring segment 617B includes a second mounting surface 614B that abuts support 606 and a second flexure portion 619B that extends inward from second mounting surface 614B, sloping towards a second spring coupling portion 618B. As shown in FIG. 6, first and second spring coupling portions 618A and 618B are coupled together at a generally apical region of flexure 610. First and second spring coupling portions 618A and 618B may be directly or indirectly coupled to each other in any suitable manner, as described herein.

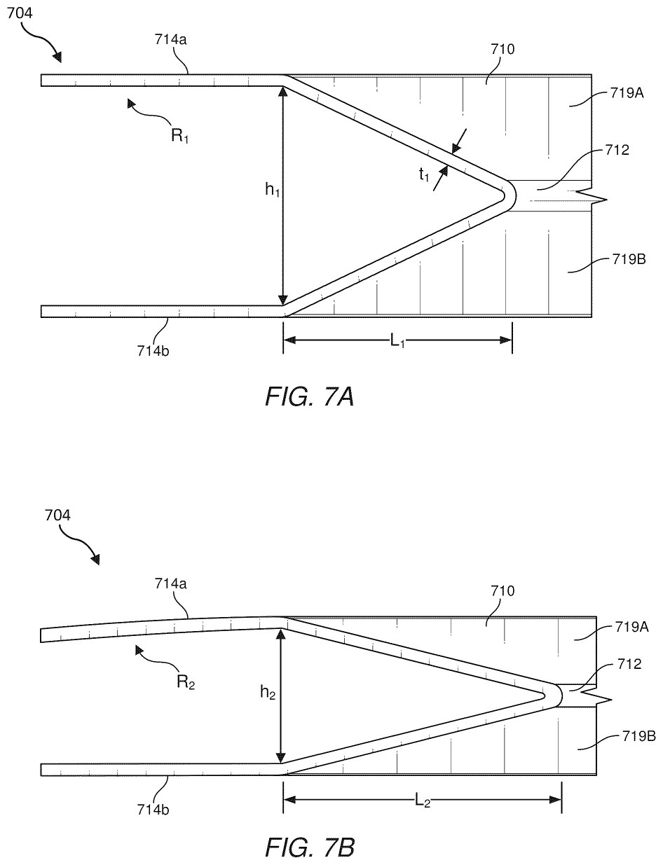

FIGS. 7A and 7B show cross-sectional portions of a spring member 704 for a liquid lens in accordance with some embodiments. Each of these views represents a view of a cross-section of spring member 704 taken along a plane extending parallel to an optical axis of the lens. As illustrated, spring member 704 includes a flexure 710 and first and second mounting surfaces 714A and 714B configured to respectively contact peripheral regions of an electromechanical actuator and a support of a liquid lens (see, e.g., FIGS. 1A-2B, 5, and 6). Flexure 710 also includes sloped first and second flexure portions 719A and 719B respectively extending from first and second mounting surfaces 714A and 714B and converging at an apical portion 712. In the example shown, spring member 704 defines a recess 716 that faces outward such that it is open to a region that is peripherally exterior to spring member 704 (in other examples, a recess may face inward so that it is filled with lens fluid when utilized in a liquid lens, as shown in FIG. 5).

FIG. 7A shows spring member 704 in a first state when, for example, spring member 704 is subjected to little or no compression between the electromechanical actuator and the support (see, e.g., FIGS. 1A and 2A). FIG. 7B shows spring member 704 in a second state when, for example, spring member 704 is compressed and/or otherwise deformed between the electromechanical actuator and the support (see, e.g., FIGS. 1B and 2B). The first and second states of spring member 704 illustrated in these figures represent states experienced when spring member 704 is utilized in a liquid lens. However, for ease of illustration, additional liquid lens components and materials (e.g., an electromechanical actuator, support, and lens fluid) are not shown in these figures.

In the first state shown in FIG. 7A, spring member 704 has a first height h₁ (e.g., a first maximum height) between first mounting surface 714A and second mounting surface 714B at the illustrated location. Additionally, flexure 710 of spring member 704 has a first length L₁ as measured laterally from an end of flexure 710 adjacent first and second mounting surfaces 714A and 714B to an end of apical region 712. First mounting surface 714A, which abuts a laterally peripheral portion of an electromechanical actuator in a liquid lens, may also slope and/or curve according to a radius of curvature R₁. While first mounting surface 714A is illustrated as being a substantially flat surface having substantially no curvature, first mounting surface 714A may have some curvature in the first state in certain examples. A thickness t₁ of flexure 710 is also illustrated in FIG. 7A. The thickness is shown as being substantially consistent throughout the portion of spring member 704 shown in these figures. However, in various examples, the thickness may vary in any suitable manner between different portions of spring member 704.

In the second state shown in FIG. 7B, spring member 704 is compressed during actuation of the electromechanical actuator. While in the second state, the electromechanical actuator exerts a force against first mounting surface 714A, forcing first mounting surface 714A towards second mounting surface 714B, which abuts the rigid support of the liquid lens. Thus, during actuation of the electromechanical actuator, spring member 704 has a second height h₂ (e.g., a second maximum height) between first mounting surface 714A and second mounting surface 714B that is less than the first height h₁ in the first state. As spring member 704 is compressed, flexure 710 of spring member 704 assumes a second length L₂ in the second state that is longer than the first length L₁ in the first state. As shown, flexure 710 may experience a significant degree of bending deformation primarily at apical region 712 as first and second mounting surfaces 714A and 714B are forced closer together by actuation of the electromechanical actuator. Additionally, first and second flexure portions 719A and 719B may pivot at apical region 712 such that an angular difference between surfaces of first and second flexure portions 719A and 719B is reduced during compression of spring member 704, thereby increasing the overall transverse length of flexure 710 to second length L₂.

Spring member 704 may include any suitable materials, such as polymer and/or metal materials, having a selected Young's modulus suitable for providing a desired spring force at various regions of spring member 704. In some examples, spring member 704, or at least a portion of spring member 704 including flexure 710, may be formed of a low modulus foam material that facilitates bending deformation of flexure 710 at apical region 712. Spring member 704 may additionally or alternatively include any other suitable porous or nonporous material in various examples.

In some examples, as shown in FIG. 7B, first mounting surface 714A may have a sloping curve with a radius of curvature R₂ in the second state due to curvature of a peripheral portion of the abutting electromechanical actuator during actuation. The thickness of spring member 704 may remain substantially the same in the first and second states, with the exception of apical region 712, which may experience a higher degree of bending deformation and, in some cases, compression. For example, a low modulus foam may be compressed or otherwise distorted at apical region 712 during compression of spring member 704, resulting in variation in thickness at that region.

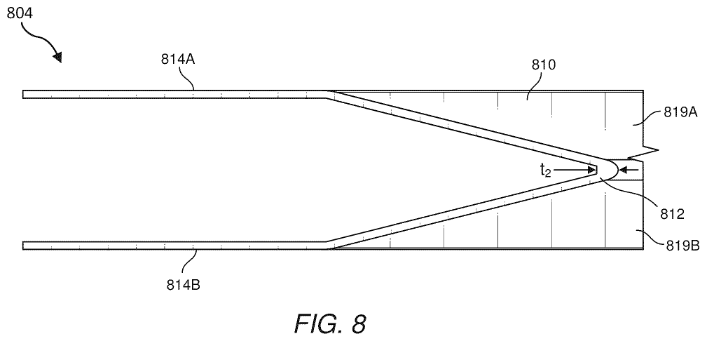

FIG. 8 shows a cross-sectional portion of a spring member 804 for a liquid lens in accordance with at least one embodiment. As illustrated, spring member 804 includes a flexure 810 and first and second mounting surfaces 814A and 814B configured to respectively contact laterally peripheral regions of an electromechanical actuator and a support of a liquid lens (see, e.g., FIGS. 1A-2B, 5, and 6). Flexure 810 includes first and second sloped portions 819A and 819B respectively extending between first and second mounting surfaces 814A and 814B and an apical portion 812. FIG. 8 shows spring member 804 in, for example, a second state during which spring member 804 is compressed due to actuation of the electromechanical actuator. Spring member 804, or at least a portion of spring member 804 including flexure 810, may be formed of a low modulus foam or other porous material that may be compressed or otherwise distorted at apical region 812 during compression of spring member 804. In this example, apical region 812 may be compressed so that it has a second thickness t₂ in the second state that is greater than a thickness (e.g., first thickness t₁ in FIG. 7A) in the first state. Additionally, because a significant degree of compression occurs at apical region 812 in comparison to other portions of spring member 804, second thickness t₂ of apical region 812 may have a greater thickness than other portions of spring member 804 in the second state, even in examples where a thickness of apical region 812 is the same or substantially the same as the other portions of spring member 804 in an uncompressed first state.

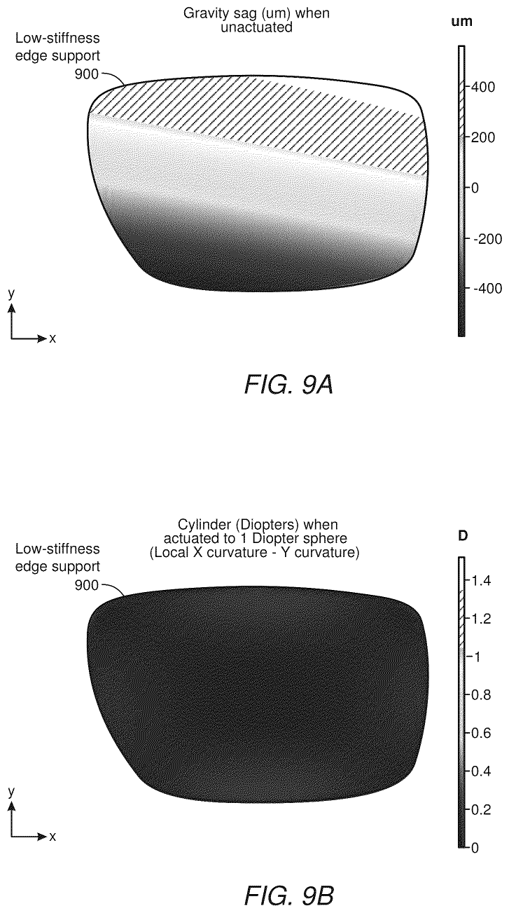

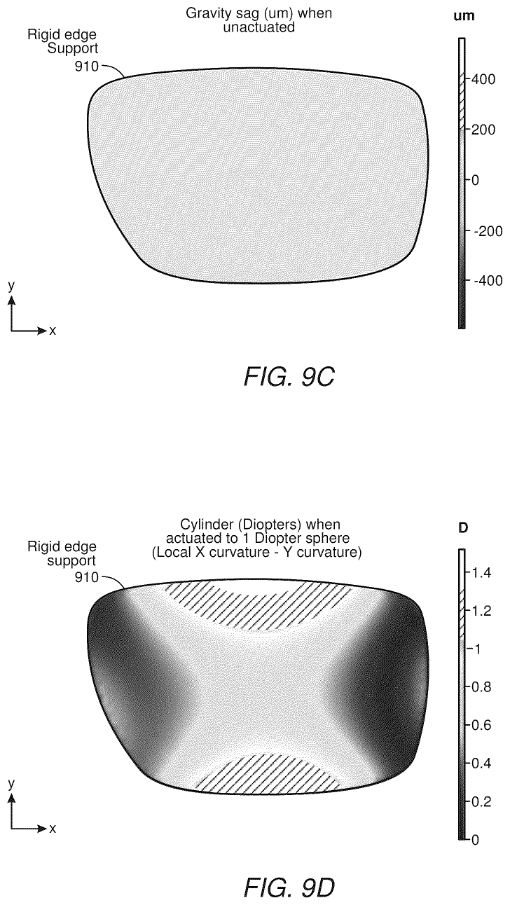

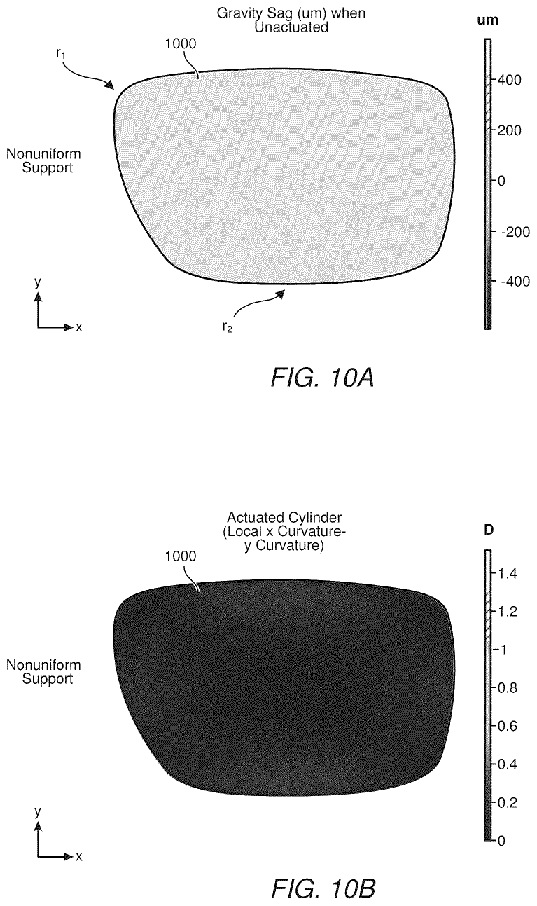

FIGS. 9A-10B illustrate characteristics of different liquid lenses in unactuated and actuated states. FIGS. 9A-9D show plots for liquid lenses having uniform-stiffness supports at the lens perimeters and FIGS. 10A and 10B show plots for a liquid lens having a nonuniform (i.e., variable) stiffness support, such as a variable-stiffness spring, at the lens perimeter in accordance with embodiments disclosed herein. Each of the plots shown in these figures represent local characteristics of the liquid lenses portrayed from a vantage point facing the lenses.

FIG. 9A shows a gravity sag plot for a liquid lens 900 having a low-stiffness edge support. Liquid lens 900 corresponds to a liquid lens having an edge support with a low amount of uniform spring force per unit length (N/m/m) along a periphery of the lens. Liquid lens 900 may represent, for example, a liquid lens having a lower-stiffness uniform edge support (e.g., a spring member or other relatively flimsy support) falling within region 432 of the plot shown in FIG. 4B (i.e., a lens with an edge support having a spring stiffness of less than approximately 2000 N/m/m). Because the edge support is relatively resilient and provides minimal support to counteract the influence of gravity on the lens fluid in an unactuated state, the effect of gravity sag may cause significant variation in the thickness of liquid lens 900, with the lens sloping and increasing in lens thickness from an upper to a lower peripheral edge. The sloping variation in lens thickness due to gravity sag may produce a noticeable prism effect that undesirably distorts a view through the lens. The effect of the gravity sag may be particularly evident to a user wearing liquid lens 900 since the direction of the prism may change as the user moves and reorients their head (FIG. 9A shows a plot of gravity sag when liquid lens 900 is oriented with a gravitational force directed downward along the Y direction, but the plot would be different for other orientations of the lens with respect to gravity).

FIG. 9B shows a plot of local cylinder values, in diopters, for liquid lens 900 when the lens is actuated to produce a 1 diopter sphere in a central region of the lens. As illustrated, the low-stiffness edge support may allow for acceptable actuation of liquid lens 900 due to the conformability of the edge support, which facilitates conformability of the liquid lens to the selected spherical shape. Accordingly, the lens shape produced during actuation of liquid lens 900 may exhibit low cylinder, particularly in a central region of the lens.

FIGS. 9C and 9D include plots for a liquid lens 910 having a rigid edge support falling within region 436 of the plot shown in FIG. 4B (i.e., a lens with an edge support having a spring stiffness of greater than approximately 10,000 N/m/m). The rigid edge support may include a material have a high degree of stiffness. In some examples, an active layer of liquid lens 910 may be securely fastened (e.g., clamped) to the edge support to prevent movement of peripheral portions of the active layer during actuation. The edge support having high stiffness may firmly hold the electromechanical actuator in place while in an unactuated state, effectively counteracting the influence of gravity on the lens fluid. Thus, as shown in FIG. 9C, there may be little or no sloping variation due to gravity sag, thus minimizing lens prism to an acceptable level that is unnoticeable to a wearer.

FIG. 9D shows a plot of local cylinder values, in diopters, over liquid lens 910 when the lens is actuated to produce a 1 diopter sphere in a central region of the lens. As illustrated, the high-stiffness edge support may prevent acceptable actuation of liquid lens 910 as the rigid edge support may not allow for sufficient movement and change in the shape of the active layer to produce a consistent cylinder over the lens area. Accordingly, the lens shape produced during actuation of liquid lens 910 may exhibit an unacceptably high degree of cylinder, particularly in a central region, as well as in upper and lower regions of the lens as shown in FIG. 9D.

In contrast to FIGS. 9A-9D, FIGS. 10A and 10B include plots for a liquid lens 1000 having a nonuniform-stiffness edge support, such as a variable-stiffness spring member, according to embodiments disclosed herein. The variable-stiffness spring member may have a stiffness profile that varies so as to enable sphere formation during actuation while exhibiting an acceptably minimal amount of gravity sag and prism in an unactuated state of liquid lens 1000 and an acceptably minimal amount of cylinder in an actuated state. As described herein, the edge support in various embodiments may include a spring member (see, e.g., FIGS. 1A-3 and 5-8) that is formed of a non-rigid material. The spring member may include a material or combination of materials that varies in stiffness proceeding around a periphery of the lens. The variation in stiffness along the spring member may be tuned to produce the desired lens characteristics when liquid lens 1000 is in each of the unactuated and actuated states. Any suitable factor and/or combination of factors affecting the stiffness of the edge support may be varied between different portions of the spring member to achieve the desired variation in stiffness at different locations along the periphery of liquid lens 1000. While one or two factors may be changed between portions of the spring member for purposes of simplicity, it is noted that any number of factors may be varied alone or in combination to produce a nonuniform spring stiffness profile.

As shown in FIG. 10A, which shows a plot of local cylinder values, in diopters, over liquid lens 1000, the lens may exhibit little or no sloping variation due to gravity sag, thus minimizing lens prism to an acceptable level that is relatively unnoticeable to a wearer. Additionally, FIG. 10B, shows a plot of local cylinder values, in diopters, over liquid lens 1000 when the lens is actuated to produce a 1 diopter sphere in a central region of the lens. As illustrated, the liquid lens 1000 may exhibit acceptable actuation, producing a lens shape with low cylinder, particularly in a central region of the lens, during actuation.

In at least one embodiment, a spring stiffness of an edge support, such as a disclosed spring member, may vary as function of multiple factors related to material composition and shape of the spring member. For example, a spring stiffness k of a spring member may vary at different locations according to an example expression k=f(L, t, r_{c}, E, h, Δz). In the expression, k is a spring stiffness at a particular peripheral location of the spring member, L is a lateral length (i.e., a bag length) of a flexure of the spring member (see, e.g., L₁ in FIG. 7A), and r_{c} is an edge radius of curvature at the lens periphery location. For example, as illustrated in FIG. 10A, a first edge radius of curvature r₁ at the indicated location along the lens periphery may be substantially lower than a second edge radius of curvature r₂ at another indicated location. Referring back to the example expression, E is the Young modulus of a material(s) forming the spring member, h is a thickness (e.g., a fluid thickness) between an electromechanical actuator and a support and/or corresponding portions of the spring member (see, e.g., h₁ in FIG. 7B), and Δz is a position change between an unactuated and an actuated state (e.g., a change between heights h₁ and h₂ shown in FIGS. 7A and 7B).

Factors affecting the k spring stiffness of the spring member at various locations may be tuned to obtain desired characteristics of liquid lens 1000 in both an unactuated and an actuated state. In various embodiments, the spring stiffness may be correlated to characteristics exhibited in the liquid lens in actuated and unactuated states. For example, portions of the spring member adjacent lens regions that must undergo a smaller amount of deformation to achieve a spherical profile during actuation may have a higher degree of stiffness. Additionally, portions of the spring member adjacent lens regions that must undergo a greater amount of deformation to achieve the spherical profile may have a lower degree of stiffness.

In some examples, a stiffness profile of the spring member may be modified during use to adjust for changes in spring characteristics. For example, one or more heating elements may be disposed near peripheral regions of a liquid lens to heat portions of the spring member. The heat may modify the Young's modulus of the spring member on the fly, enabling dynamic adjustment of the spring member (e.g., to obtain a desired modulus when used in cold temperature conditions, to correct for changes due to wear and tear, etc.).

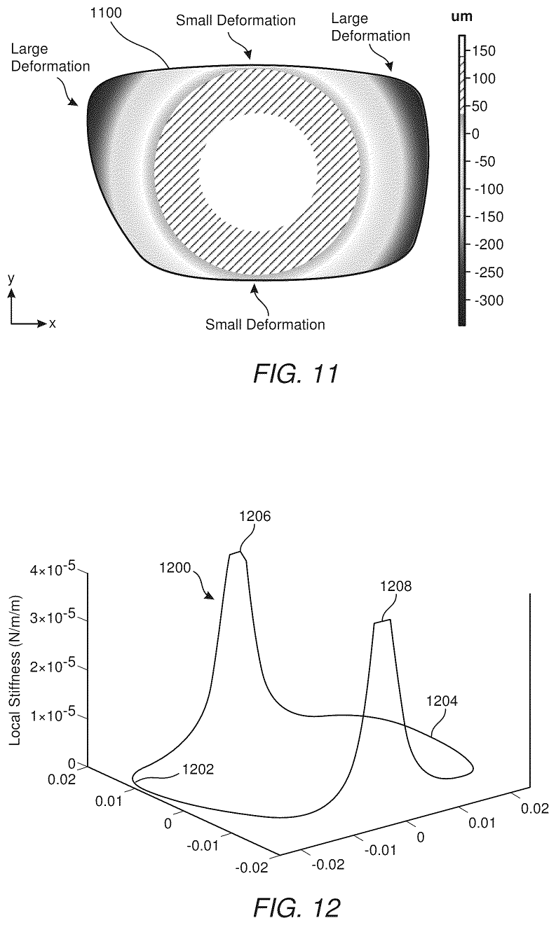

FIG. 11 illustrates amounts of deformation required at different locations of an exemplary liquid lens 1100 during actuation to form a spherical lens shape. This figure shows a plot indicating required amounts of deformation (in μm) required to produce a spherical lens shape (e.g., a lens with a 1 diopter sphere), according to at least one embodiment. As illustrated, a high degree of deformation may be required at the left and right edge portions of liquid lens 1100, which has a noncircular periphery. The stiffness of a spring member of liquid lens 1100 may be lower at the edge regions requiring a large amount of deformation so as to allow for adequate development of the spherical lens shape during actuation. Additionally, as shown in FIG. 11, a much lower degree of deformation may be required along central portions of the top and bottom edge regions, which are located in closer proximity to a center of the targeted sphere shape. The stiffness of the spring member may be significantly higher at such edge regions that require a large amount of deformation.

FIG. 12 shows a map plotting local stiffness target values for peripheral locations along liquid lens 1100 shown in FIG. 11. The bottom two axes of the map represent X and Y coordinates along the periphery of liquid lens 1100. A third axis corresponds to local target stiffness values (N/m/m) at each coordinate along the spring member periphery. The target stiffness values may be utilized to produce a variable-stiffness spring member configured to facilitate formation of a spherical lens during actuation of liquid lens 1100. The map shown in FIG. 12 includes a curve 1200 representing local target stiffness values at locations along the lens periphery. As shown, liquid lens 1100 may require a spring member having lower amounts of stiffness at regions corresponding to higher amounts of deformation during actuation (e.g., the large deformation locations in FIG. 11), as illustrated by, for example, regions 1202 and 1204. Additionally, liquid lens 1100 may require much higher amounts of stiffness at regions corresponding to lower amounts of deformation during actuation (e.g., the small deformation locations in FIG. 11), as illustrated by, for example, peak regions 1206 and 1208.

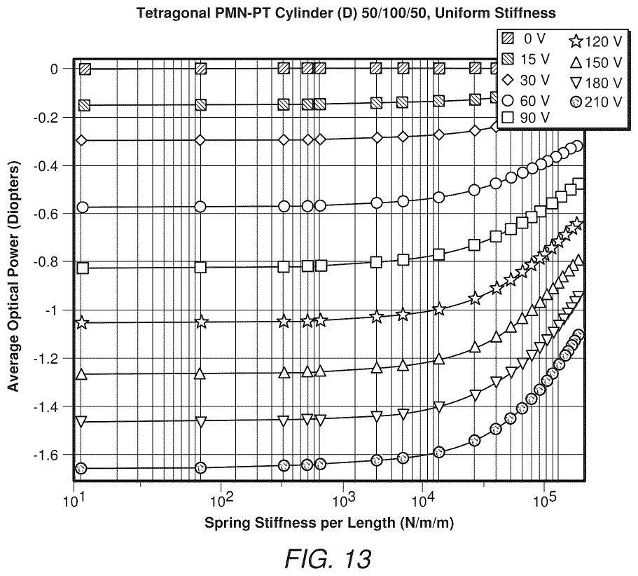

FIGS. 13-16 demonstrate improvements in lens actuation obtained using spring members having nonuniform spring stiffness distributions (see, e.g., FIGS. 10-12) in comparison to a spring members having uniform spring stiffnesses over their peripheries (see, e.g., FIGS. 9A-9D). The electromechanical actuator utilized in each of these examples includes a tetragonal PMN-PT piezoelectric material in an electroactive layer.

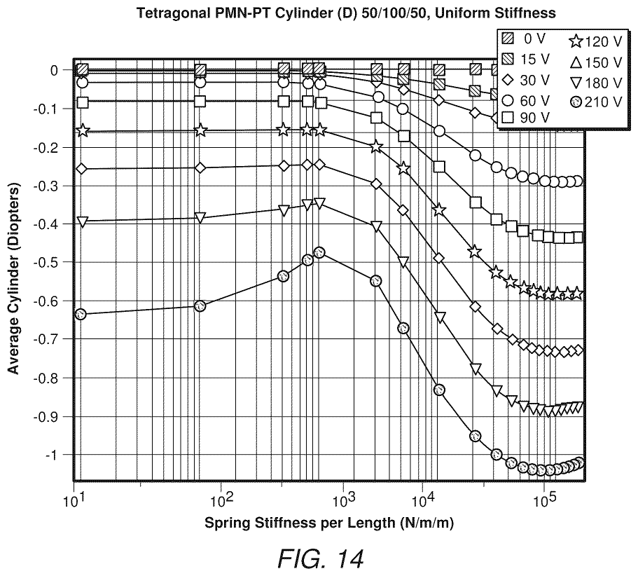

FIG. 13 shows a plot of average optical power (diopters) versus spring stiffness per unit of length (N/m/m) for liquid lenses having uniform-stiffness support members. The curves shown illustrate spring stiffnesses and corresponding optical powers exhibited at various voltages, which are applied to the example PMN-PT electromechanical actuator of the lenses. Curves are shown for 0 V, 15 V, 30 V, 60 V, 90 V, 120 V, 150 V, 180 V, and 210 V. FIG. 14 shows a plot of average cylinder (in diopters) versus spring stiffness per length (N/m/m) for the liquid lens having a uniform-stiffness support member, as represented in FIG. 13. As shown in FIG. 14, for actuation voltages above 0 V, the average cylinder increases dramatically at higher stiffness values for the uniform-stiffness support lenses. For example, the average cylinder increases substantially at uniform spring stiffness values above 1000 N/m/m, which may result in the liquid lenses having unacceptable amounts of cylinder during actuation when higher uniform spring stiffnesses are used.

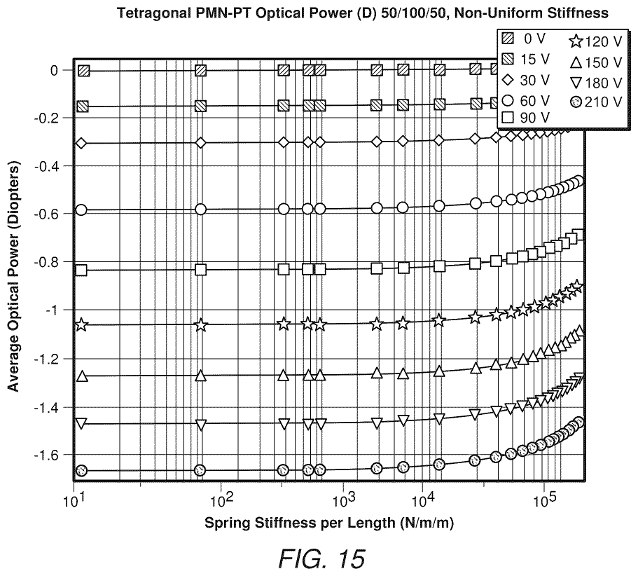

In contrast to FIGS. 13 and 14, FIGS. 15 and 16 show actuation values for liquid lenses having the same type of tetragonal PMN-PT actuator, but with nonuniform (i.e., variable) stiffness spring members used for support along the lens periphery. FIG. 15 shows a plot of average optical power (diopters) versus spring stiffness per length (N/m/m) for the nonuniform-stiffness liquid lenses. The curves shown illustrate the spring stiffnesses and corresponding optical powers obtained at various voltages (0 V, 15 V, 30 V, 60 V, 90 V, 120 V, 150 V, 180 V, and 210 V) applied to the example electromechanical actuator. In comparison to the uniform-stiffness support lenses shown in FIG. 13, the nonuniform-stiffness support lenses represented in FIG. 15 maintain higher amounts of optical power at higher spring stiffness and voltage values.

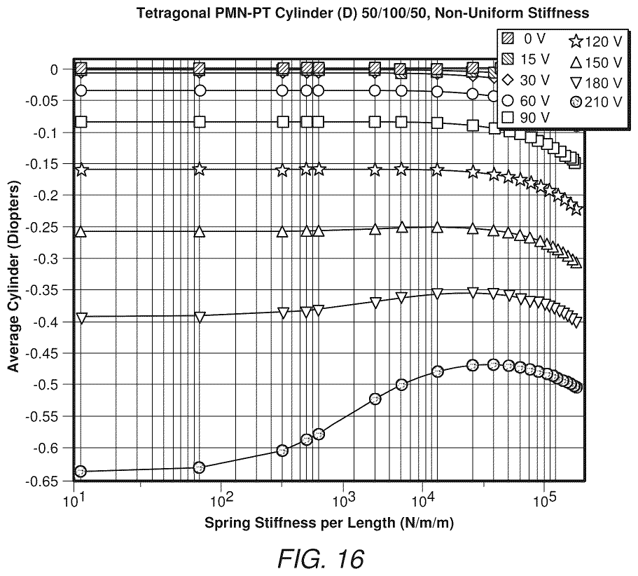

FIG. 16 shows a plot of average cylinder (in diopters) versus spring stiffness per length (N/m/m) for the liquid lenses having a nonuniform-stiffness spring member, as represented in FIG. 15. As shown in FIG. 16, there is very little increase in average cylinder, even at higher stiffness values above approximately 1000 N/m/m, for the nonuniform-stiffness support lens. Accordingly, the actuated liquid lenses having nonuniform-stiffness spring members for edge support show improved optical characteristics (e.g., minimized cylinder) for various spheres and spring stiffness values in comparison to lenses with uniform-stiffness supports.

By way of example, a voltage of 120 V may be applied to the electroactive actuators of the nonuniform and uniform-stiffness lenses to obtain an optical power of approximately 1 Diopter. For the uniform-stiffness lens, a spring stiffness of approximately 10,000 N/m/m may be required at 120 V, as shown in FIG. 13. Assuming, for example, a specified cylinder value for the actuated lens must be no more than approximately 0.25 Diopters, FIG. 14 makes clear that the average cylinder for the uniform-stiffness lens would have an unacceptably high value of approximately 0.35 Diopters for the spring stiffness of approximately 10,000 N/m/m at 120 V. In contrast, for the nonuniform-stiffness lens, a spring stiffness of approximately 15,000 N/m/m may be required at 120 V to obtain an optical power of approximately 1 Diopter, as shown in FIG. 15. As shown in FIG. 16, the average cylinder for the nonuniform-stiffness lens would have an acceptable value of approximately 0.18 Diopters for the spring stiffness of approximately 15,000 N/m/m at 120 V.

In addition to facilitating the production of lenses having acceptable lens characteristics in both unactuated and actuated states, variable-stiffness spring members having nonuniform-stiffness profiles, as disclosed herein, may also facilitate production of liquid lenses having decentered profiles. A decentered profile liquid lens may be actuated to produce an optical sphere centered at a location different than a center of the lens. A spring member may be tuned, for example, to generate a decentered sphere at a selected location during actuation. Such decentration may be advantageous, for example, to accommodate lenses suitable for use by a variety of wearers, included wearers having a range of interpupillary distances (IPDs).

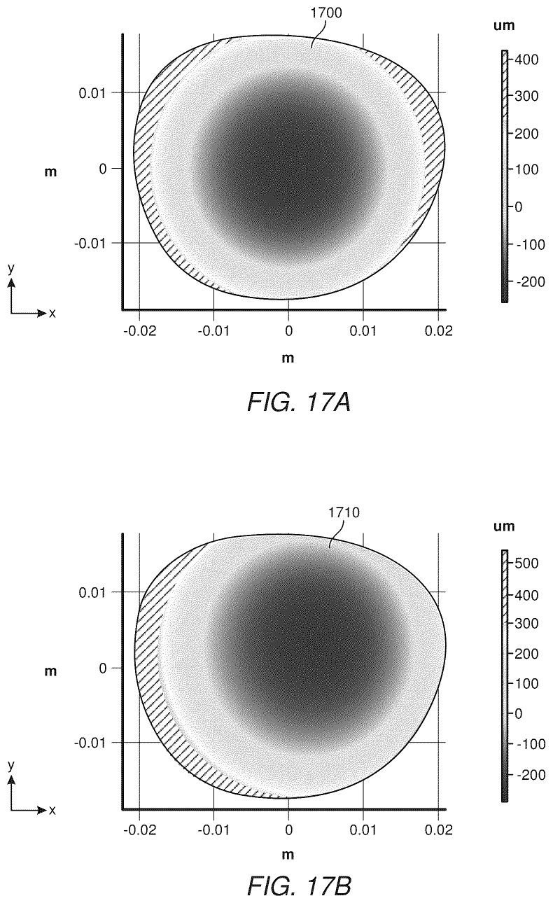

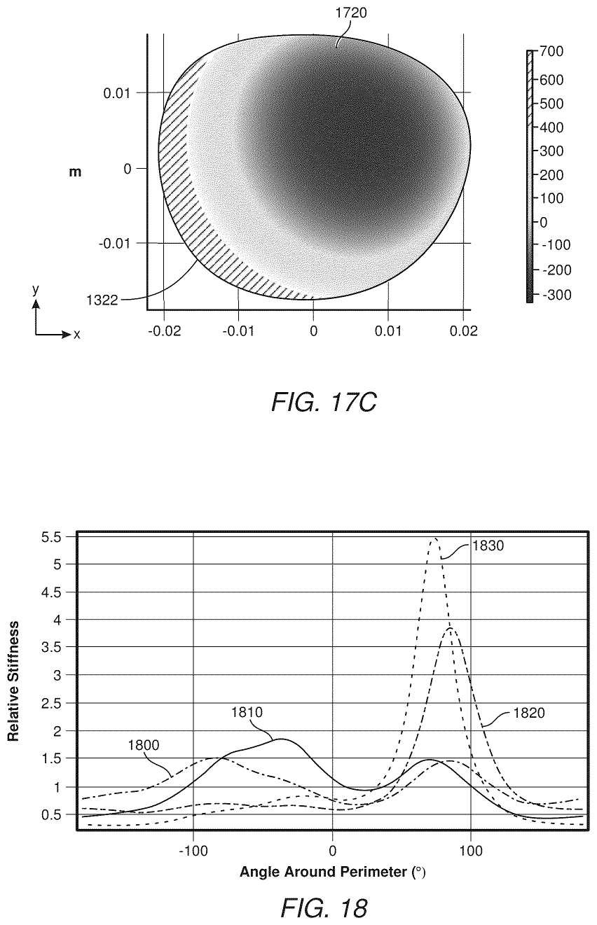

FIGS. 17A-17C illustrate lenses with spheres centered at various locations within a lens. These figures show plots of liquid lenses with spherical deformation (in μm) at various lens locations. FIG. 17A shows a liquid lens 1700 with an actuated sphere centered at a box center (e.g., centroid) of the lens. FIG. 17B illustrates a liquid lens 1710 with an actuated sphere that is decentered (i.e., the sphere is centered at a location of 2.5 mm, 2.5 mm relative to the lens box center). FIG. 17C illustrates a liquid lens 1720 with an actuated sphere that is decentered (i.e., the sphere is centered at a location of 5 mm, 5 mm relative to the lens box center).

FIG. 18 shows a plot of target relative stiffness values versus angular peripheral lens locations for various lenses having variable-stiffness spring members for producing actuated lenses with decentered spheres. Curve 1800 shows relative stiffness values along a liquid lens perimeter for a lens that produces a sphere centered at the box center (0 mm, 0 mm) of the lens. Curves 1810, 1820, and 1830 show relative stiffness values for liquid lenses that produce decentered spheres when actuated. Curve 1810 shows values for a liquid lens that produces a sphere centered at 2.5 mm, 0 mm relative to the box center, curve 1820 shows values for a liquid lens that produces a sphere centered at 0 mm, 2.5 mm relative to the box center, and curve 1830 shows values for a liquid lens that produces a sphere centered at 2.5 mm, 2.5 mm relative to the box center. As shown, a peak relative stiffness may increase with increasing decentration of the actuated lens sphere. Variable-stiffness spring members may be tuned to effectively accommodate variations in stiffness around the lens perimeter for a variety of decentered spheres.

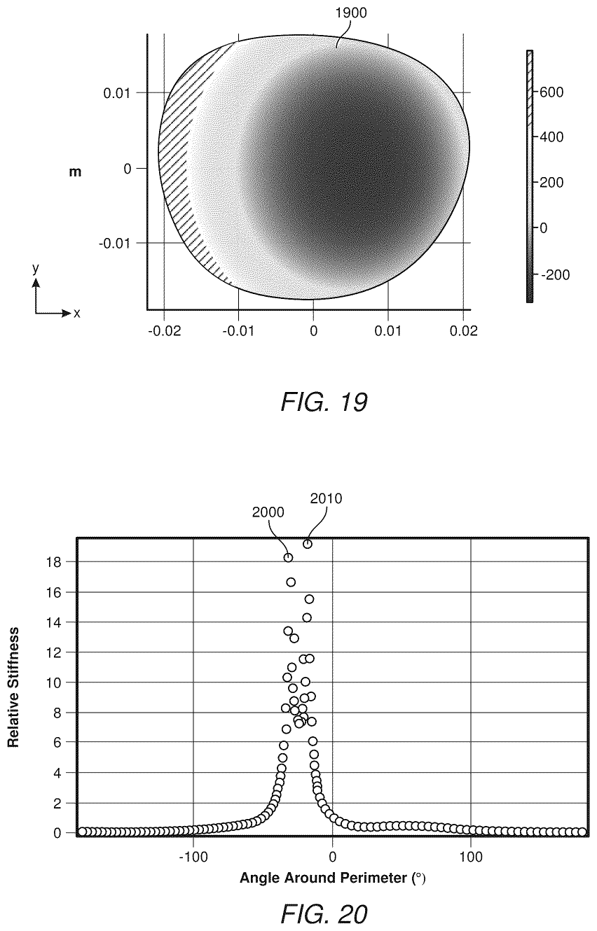

In some cases, when an actuated lens sphere of a liquid lens is decentered to a significant extent, one or more points along the lens periphery may require excessive stiffness at the edge support and, in some instances, an infinite stiffness (i.e., a “singularity” in stiffness) to produce a sphere at the decentered location. For example, FIG. 19 illustrates a liquid lens 1900 with an actuated sphere that is decentered, with the sphere centered at a location of 5 mm, 0 mm relative to the lens box center. FIG. 20 shows a plot of target relative stiffness values versus angular location along a lens perimeter for the decentered lens of FIG. 19. As shown in FIG. 20, two peripheral regions 2000 and 2010 located between angular locations of from approximately −45° to approximately 0° increase drastically in target stiffness. Such levels of stiffness may be impractical to produce using a spring member or other edge support suitable for use in a liquid lens. Accordingly, in order to produce certain liquid lenses having decentered spheres, various adjustments may be made to a peripheral stiffness profile at locations that might otherwise require excessively rigid edge support value.

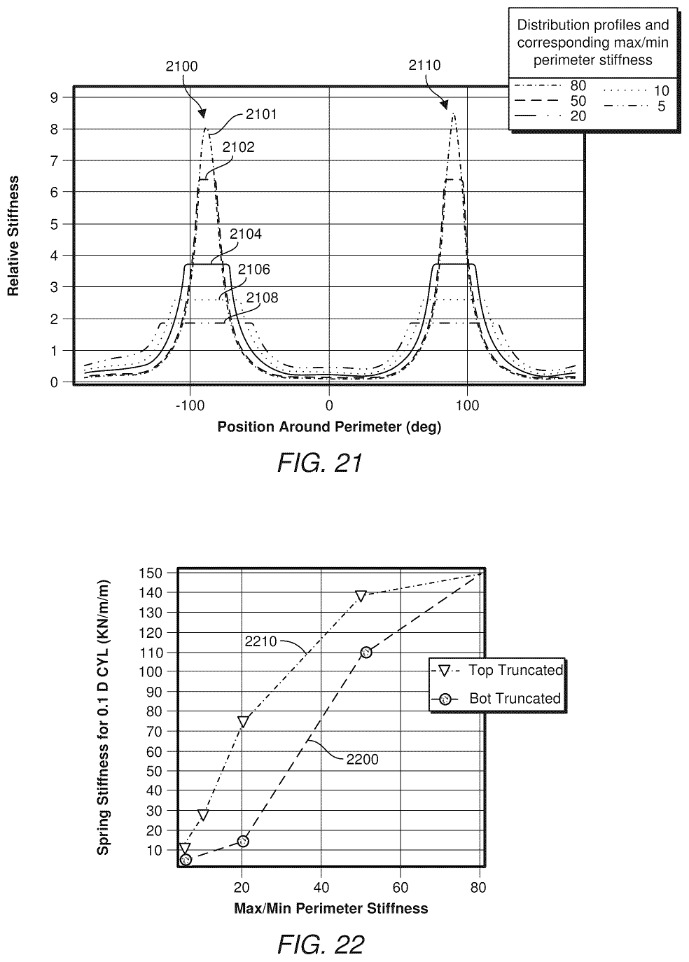

In some embodiments, a peripheral stiffness profile may be truncated to decrease the maximum stiffness of a variable-stiffness spring member. FIGS. 21 and 22 illustrate plots for variable spring stiffness members having truncated stiffness distributions. The distributions may be truncated, for example, in situations where certain calculated target stiffness values are determined to be higher than feasible for a variable-stiffness spring (see, e.g., the target stiffness distribution for a lens having a decentered actuated sphere, as illustrated in FIGS. 19 and 20). As shown in FIG. 21, a target peripheral stiffness distribution 2101 for an actuated liquid lens may include two peak regions, including a bottom peak 2100 and a top peak 2110, where the stiffness values may increase to levels that are impractical or unfeasible to obtain using a spring member located at the lens periphery. The target peripheral stiffness distribution 2101 has a maximum relative stiffness value of approximately 8 at the bottom peak 2100 and approximately 8.5 at the top peak 2110, and a ratio of maximum/minimum stiffness for target peripheral stiffness distribution 2101 has a value of approximately 80.

In addition to the calculated target peripheral stiffness distribution 2101 determined for the decentered spherical lens profile, FIG. 21 also shows a plurality of truncated stiffness distributions 2102, 2104, 2106, and 2108 for spring members that may enable formation of an acceptable sphere during liquid lens actuation while providing a more workable range of spring stiffness values. As shown, distribution 2102 is truncated to a maximum relative stiffness of approximately 6.4 at both peak regions and has a maximum/minimum stiffness value of approximately 50. Distribution 2104 is truncated to a maximum relative stiffness of approximately 3.7 at both peak regions and has a maximum/minimum stiffness value of approximately 20. Distribution 2106 is truncated to a maximum relative stiffness of approximately 2.6 at both peak regions and has a maximum/minimum stiffness value of approximately 10. Distribution 2108 is truncated to a maximum relative stiffness of approximately 1.9 at both peak regions and has a maximum/minimum stiffness value of approximately 5.

FIG. 22 shows maximum spring stiffness values (KN/m/m) at peripheral positions corresponding to the bottom peak 2100 and top peak 2110 for each of the stiffness distributions 2101, 2102, 2104, 2106, and 2108 shown in FIG. 21. The maximum spring stiffness values are the maximum values required to generate an actuated lens sphere having an acceptable cylinder of approximately 0.1 Diopter. Curve 2200 shows maximum stiffness values for truncated regions (i.e., the flattened regions in FIG. 21) at lens perimeter positions corresponding to bottom peak 2100 of FIG. 21. Additionally, curve 2210 shows maximum stiffness values for truncated regions at lens perimeter positions corresponding to top peak 2110 of FIG. 21. As shown, the maximum spring stiffness values increase for each of the bottom and top peak regions in conjunction with increases in maximum/minimum perimeter stiffness. Plots, such as those shown in FIGS. 21 and 22, may be useful for selecting an appropriate amount of perimeter stiffness truncation for particular liquid lens profiles, facilitating production of lenses that produce selected spheres, including decentered spheres, using variable-stiffness spring members with stiffness values that are acceptably low.

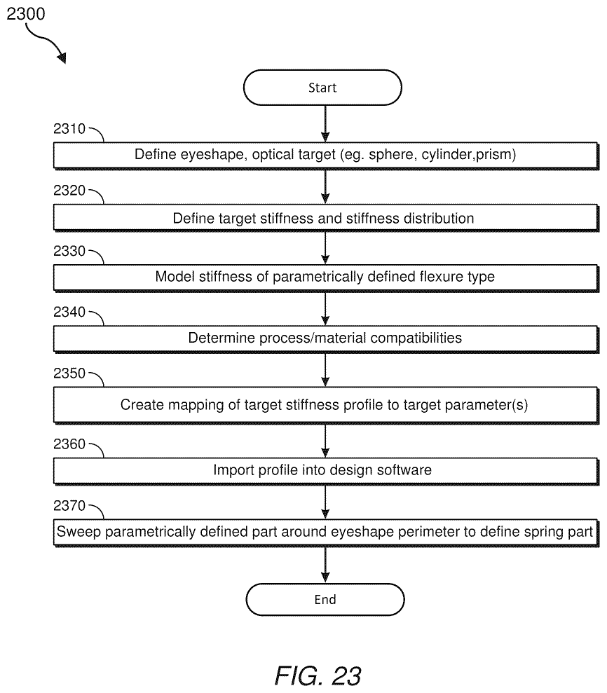

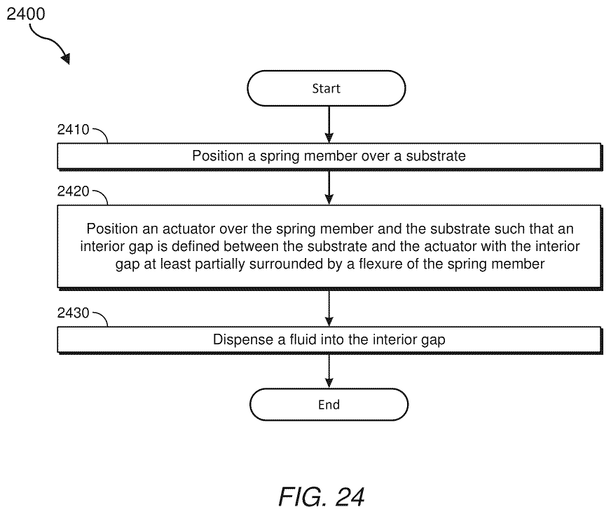

FIGS. 23 and 24 are flow diagrams of exemplary methods 2200 and 2300 for designing and producing a liquid lens in accordance with embodiments of this disclosure. FIG. 23 illustrates steps that are included in designing and modeling parameters for a variable-stiffness spring of a liquid lens, in accordance with various examples. As illustrated in FIG. 23, at step 2310, a lens eyeshape and optical target may be defined. For example, the peripheral shape of a lens may be determined and may be customized according to a particular lens use and style. The optical target may include any suitable factors, including a target sphere, cylinder, and prism. In some examples, a particular lens sphere may be targeted for an actuated state of the lens and a target value for optical prism (e.g., due to gravity sag) may be minimized for an unactuated state. A target cylinder value representing an amount of cylinder error (as opposed to prescriptive cylinder correction) may be minimized for the actuated state of the lens as well. By way of example, target values for a lens may specify that, when actuated to sphere of approximately 1 Diopter, the lens has a maximum threshold value of approximately 0.25 Diopter prism in the unactuated state and a maximum threshold value of approximately 0.25 Diopter cylinder in the actuated state.

At step 2320 in FIG. 23, a target stiffness and/or stiffness distribution at the lens periphery may be defined. For example, a target stiffness distribution may be determined to produce a target actuated sphere with sufficiently minimal amounts of prism and cylinder error in accordance with the target values determined in step 2310. Target variable stiffness distributions for liquid lenses may be found, for example, in FIGS. 12, 15, 16, 18, 20, and 21.

At step 2330 in FIG. 23, stiffness values for a parametrically defined flexure type may be modeled. For example, a stiffness profile for a particular type of variable-stiffness spring member/flexure type may be modeled by adjusting one or more selected parameters of the spring member/flexure to obtain the selected stiffness profile at a periphery of the liquid lens. Any suitable parameters may be adjusted to produce a selected outcome. Adjustment of a single parameter may simplify modeling and production of the spring member. However, adjusting two or more parameters may provide a greater range of potential stiffnesses and may be utilized to accommodate a variety of stiffness distributions and other needs. Examples of parameters that may be adjusted may include bag length (i.e., the length L₁ of flexure 710 about the perimeter as shown in FIG. 7A), bag thickness (i.e., the height h₁ of the flexure shown in FIG. 7A), the elastic modulus of one or more materials forming the spring member, and the thickness (e.g., thickness t₁ shown in FIG. 7A) of portions of the spring member. Any other suitable parameters affecting stiffness of the spring member may additionally or alternatively be modeled and adjusted at various locations along the spring member.

At step 2340 in FIG. 23, process and/or material compatibilities may be determined for producing a particular spring member. For example, materials may be selected that are capable of providing the determined stiffness profiles and that are capable of producing the spring member within any indicated size constraints required by the lens design. Materials may include, for example, elastomeric polymers and/or metals. In some cases, polymer foams may be utilized. A particular production process capable of manufacturing a spring member at the needed scale and shape may also be determined. Examples of suitable manufacturing methods for producing polymer spring members may include, for example, injection molding, thermoforming, inkjet printing, and 3D printing. Methods for manufacturing metal spring members may include, for example, metal stamping, die casting, and machining. In some examples, where two or more parts are coupled together to form the spring member (see, e.g., FIGS. 5 and 6), the manufacturing process may include a bonding step (e.g., using an adhesive) and/or a welding step (e.g., to bond two metal components).

At step 2350 in FIG. 23, the target stiffness profile may be mapped to one or more target parameters. For example, a 1 to 1 mapping of target stiffnesses about a liquid lens perimeter to a target parameter of a spring member may be made. In one example, a material having a particular modulus may be selected and a particular material thickness may be chosen. In this example, the bag length (e.g., the length L₁ of the flexure 710 in FIG. 7A) may be mapped 1 to 1 with the target stiffness distribution so that the determined bag length along the spring member varies along its length to provide the target stiffnesses. Other parameters that may be mapped to the stiffness profile include, for example, spring material thickness, spring height, Young's modulus, edge radius of curvature, and position change with actuation.

At step 2360 in FIG. 23, the mapped profile for the determined stiffness profile may be imported into a design application configured to produce a part consistent with the profile. For example, a mapped profile for a spring member that varies in bag length may be imported into a computer-aided design (CAD) program to produce a spring member design that meets the determined parameter constraints within an acceptable tolerance.

At step 2370 in FIG. 23, the parametrically defined spring part may be swept around the liquid lens eyeshape perimeter to define the spring part shape. For example, where stiffness distribution of the spring member is determined to vary by changing the bag length (i.e., flexure length L₁), the design program may be utilized to sweep the spring part design around the eyeshape perimeter to arrive at a suitable design shape that varies in bag length around the perimeter of the spring member. In some examples, certain portions of the spring member may be designed to produce stiffnesses in one or more regions that vary from calculated target stiffnesses (see, e.g., FIG. 21, where portions of the stiffness profile are truncated to provide an acceptable lens shape while modifying the stiffness in regions determined to have excessive target stiffnesses).

FIG. 24 shows an exemplary method 2400 for manufacturing a liquid lens in accordance with various embodiments. At step 2410 in FIG. 24, a spring member may be positioned over a substrate. For example, a spring member 104 may be positioned over a support 106, as shown in FIG. 1A (see also FIGS. 2A, 4A, 5 and 6). In some examples, the spring member may be aligned with a periphery of the substrate and/or a portion of the substrate configured to overlap a periphery of an electromechanical actuator. In various examples, the spring member may be coupled to the substrate so as to seal in a lens liquid. For example, a portion of the spring member may be bonded (e.g., via an adhesive) or otherwise adhered or fastened to the substrate in any suitable manner that prevents leakage of a lens fluid from a space between the spring member and the substrate.

At step 2420 in FIG. 24, an actuator may be positioned over the spring member and the substrate such that an interior gap is defined between the substrate and the actuator with the interior gap at least partially surrounded by a flexure of the spring member. For example, electromechanical actuator 102 may be positioned over spring member 104, as shown in FIG. 1A (see also FIGS. 2A, 4A, 5 and 6). In at least one example, a spring stiffness of the flexure may differ at each of at least two peripheral locations around the interior gap (see, e.g., FIGS. 12, 15, 16, and 18-22). In various examples, the spring member may be coupled to the actuator so as to seal in a lens liquid and prevent leakage from a region between the spring member and the actuator.

At step 2430 in FIG. 24, a fluid, such as a lens fluid, may be dispensed into the interior gap. For example, a lens fluid 108 may be dispensed (e.g., injected) into the interior gap defined by electromechanical actuator 102, support 106, and spring member 104, as shown in FIG. 1A (see also, FIGS. 2A, 4A, 5, and 6). In some examples, an opening required for introducing the lens fluid into the fluid lens may be sealed in any suitable manner to prevent subsequent leakage of the lens fluid.

Aspects of the present disclosure relate to the incorporation of a variable-stiffness support element, such as a nonuniform-stiffness spring member, into a deformable fluid lens. Relative to comparative approaches, the spring member may provide a balance of improved optical characteristics in both unactuated and actuated states. The variable-stiffness spring member may be designed to facilitate formation of a spherical lens shape during actuation of an active membrane. Additionally, the spring member may provide peripheral edge support in an unactuated state that is sufficient to minimize the effects of gravity sag.

### EXAMPLE EMBODIMENTS

Example 1: An apparatus includes a substrate, an actuator, and a spring member disposed between the substrate and the actuator, where the spring member includes a flexure that at least partially surrounds a central region and a spring stiffness of the flexure differs at each of at least two peripheral locations around the central region.

Example 2: The apparatus of Example 1, where the flexure extends between the actuator and the substrate along a path that protrudes radially outward or inward with respect to the central region.

Example 3: The apparatus of any of Examples 1 and 2, where the flexure has a generally V-shaped cross-sectional surface.

Example 4: The apparatus of any of Examples 1-3, where the flexure protrudes radially outward or inward to a different extent at each of the at least two peripheral locations.

Example 5: The apparatus of any of Examples 1-4, where the flexure includes a resilient material.

Example 6: The apparatus of any of Examples 1-5, where the flexure includes a different resilient material or combination of resilient materials at each of the at least two peripheral locations.

Example 7: The apparatus of any of Examples 1-6, where the resilient material or combination of resilient materials has a different Young's modulus at each of the at least two peripheral locations.

Example 8: The apparatus of any of Examples 1-7, where the spring member further includes a base surface adjacent the substrate and an actuation surface adjacent the actuator.

Example 9: The apparatus of Example 8, where the actuation surface overlaps the base surface between the actuator and the substrate.

Example 10: The apparatus of any of Examples 8 and 9, where a distance between the actuation surface and the base surface differs at each of the at least two peripheral locations.

Example 11: The apparatus of any of Examples 1-10, where the actuator includes an electromechanical actuator configured to compress the flexure in response to a change in voltage applied to the electromechanical actuator.

Example 12: The apparatus of Examples 11, where the electromechanical actuator includes at least one piezoelectric layer.

Example 13: The apparatus of any of Examples 1-12, where the flexure has a different layer thickness at each of the at least two peripheral locations.

Example 14: A fluid lens includes the apparatus of any of Examples 1-13.

Example 15: A fluid lens includes a substrate, an actuator, a fluid layer disposed between the substrate and the actuator, and a spring member disposed between the substrate and the actuator, where the spring member includes a flexure that at least partially surrounds the fluid layer and a spring stiffness of the flexure differs at each of at least two peripheral locations around the fluid layer.

Example 16: The fluid lens of Example 15, where the spring member seals the fluid between the substrate and the actuator.

Example 17: The fluid lens of any of Examples 15 and 16, where the spring member defines a noncircular profile around the fluid layer.

Example 18: A method includes i) positioning a spring member over a substrate, ii) positioning an actuator over the spring member and the substrate such that an interior gap is defined between the substrate and the actuator with the interior gap at least partially surrounded by a flexure of the spring member, where a spring stiffness of the flexure differs at each of at least two peripheral locations around the interior gap, and iii) dispensing a fluid into the interior gap.

Example 19: The method of Example 18, further including forming the spring member such that the spring stiffness of the flexure at each of the at least two peripheral locations results in a lens shape having a selected optical power and cylinder at each of at least two different voltages applied to the actuator.

Example 20: The method of any of Examples 18 and 19, where the spring member defines a noncircular profile around the fluid.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 2500 in FIG. 25) or that visually immerses a user in an artificial reality (such as, e.g., virtual-reality system 2600 in FIG. 26). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 25, augmented-reality system 2500 may include an eyewear device 2502 with a frame 2510 configured to hold a left display device 2515(A) and a right display device 2515(B) in front of a user's eyes. Display devices 2515(A) and 2515(B) may act together or independently to present an image or series of images to a user. While augmented-reality system 2500 includes two displays, embodiments of this disclosure may be implemented in augmented-reality systems with a single NED or more than two NEDs.

In some embodiments, augmented-reality system 2500 may include one or more sensors, such as sensor 2540. Sensor 2540 may generate measurement signals in response to motion of augmented-reality system 2500 and may be located on substantially any portion of frame 2510. Sensor 2540 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2500 may or may not include sensor 2540 or may include more than one sensor. In embodiments in which sensor 2540 includes an IMU, the IMU may generate calibration data based on measurement signals from sensor 2540. Examples of sensor 2540 may include, without limitation, accelerometers, gyroscopes, magnetometers, other suitable types of sensors that detect motion, sensors used for error correction of the IMU, or some combination thereof.

In some examples, augmented-reality system 2500 may also include a microphone array with a plurality of acoustic transducers 2520(A)-2520(J), referred to collectively as acoustic transducers 2520. Acoustic transducers 2520 may represent transducers that detect air pressure variations induced by sound waves. Each acoustic transducer 2520 may be configured to detect sound and convert the detected sound into an electronic format (e.g., an analog or digital format). The microphone array in FIG. 25 may include, for example, ten acoustic transducers: 2520(A) and 2520(B), which may be designed to be placed inside a corresponding ear of the user, acoustic transducers 2520(C), 2520(D), 2520(E), 2520(F), 2520(G), and 2520(H), which may be positioned at various locations on frame 2510, and/or acoustic transducers 2520(I) and 2520(J), which may be positioned on a corresponding neckband 2505.

In some embodiments, one or more of acoustic transducers 2520(A)-(J) may be used as output transducers (e.g., speakers). For example, acoustic transducers 2520(A) and/or 2520(B) may be earbuds or any other suitable type of headphone or speaker.

The configuration of acoustic transducers 2520 of the microphone array may vary. While augmented-reality system 2500 is shown in FIG. 25 as having ten acoustic transducers 2520, the number of acoustic transducers 2520 may be greater or less than ten. In some embodiments, using higher numbers of acoustic transducers 2520 may increase the amount of audio information collected and/or the sensitivity and accuracy of the audio information. In contrast, using a lower number of acoustic transducers 2520 may decrease the computing power required by an associated controller 2550 to process the collected audio information. In addition, the position of each acoustic transducer 2520 of the microphone array may vary. For example, the position of an acoustic transducer 2520 may include a defined position on the user, a defined coordinate on frame 2510, an orientation associated with each acoustic transducer 2520, or some combination thereof.

Acoustic transducers 2520(A) and 2520(B) may be positioned on different parts of the user's ear, such as behind the pinna, behind the tragus, and/or within the auricle or fossa. Or, there may be additional acoustic transducers 2520 on or surrounding the ear in addition to acoustic transducers 2520 inside the ear canal. Having an acoustic transducer 2520 positioned next to an ear canal of a user may enable the microphone array to collect information on how sounds arrive at the ear canal. By positioning at least two of acoustic transducers 2520 on either side of a user's head (e.g., as binaural microphones), augmented-reality system 2500 may simulate binaural hearing and capture a 3D stereo sound field around about a user's head. In some embodiments, acoustic transducers 2520(A) and 2520(B) may be connected to augmented-reality system 2500 via a wired connection 2530, and in other embodiments acoustic transducers 2520(A) and 2520(B) may be connected to augmented-reality system 2500 via a wireless connection (e.g., a BLUETOOTH connection). In still other embodiments, acoustic transducers 2520(A) and 2520(B) may not be used at all in conjunction with augmented-reality system 2500.

Acoustic transducers 2520 on frame 2510 may be positioned in a variety of different ways, including along the length of the temples, across the bridge, above or below display devices 2515(A) and 2515(B), or some combination thereof. Acoustic transducers 2520 may also be oriented such that the microphone array is able to detect sounds in a wide range of directions surrounding the user wearing the augmented-reality system 2500. In some embodiments, an optimization process may be performed during manufacturing of augmented-reality system 2500 to determine relative positioning of each acoustic transducer 2520 in the microphone array.

In some examples, augmented-reality system 2500 may include or be connected to an external device (e.g., a paired device), such as neckband 2505. Neckband 2505 generally represents any type or form of paired device. Thus, the following discussion of neckband 2505 may also apply to various other paired devices, such as charging cases, smart watches, smart phones, wrist bands, other wearable devices, hand-held controllers, tablet computers, laptop computers, other external computer devices, etc.

As shown, neckband 2505 may be coupled to eyewear device 2502 via one or more connectors. The connectors may be wired or wireless and may include electrical and/or non-electrical (e.g., structural) components. In some cases, eyewear device 2502 and neckband 2505 may operate independently without any wired or wireless connection between them. While FIG. 25 illustrates the components of eyewear device 2502 and neckband 2505 in example locations on eyewear device 2502 and neckband 2505, the components may be located elsewhere and/or distributed differently on eyewear device 2502 and/or neckband 2505. In some embodiments, the components of eyewear device 2502 and neckband 2505 may be located on one or more additional peripheral devices paired with eyewear device 2502, neckband 2505, or some combination thereof.

Pairing external devices, such as neckband 2505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2500 may be provided by a paired device or shared between a paired device and an eyewear device, thus reducing the weight, heat profile, and form factor of the eyewear device overall while still retaining desired functionality. For example, neckband 2505 may allow components that would otherwise be included on an eyewear device to be included in neckband 2505 since users may tolerate a heavier weight load on their shoulders than they would tolerate on their heads. Neckband 2505 may also have a larger surface area over which to diffuse and disperse heat to the ambient environment. Thus, neckband 2505 may allow for greater battery and computation capacity than might otherwise have been possible on a stand-alone eyewear device. Since weight carried in neckband 2505 may be less invasive to a user than weight carried in eyewear device 2502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2505 may be communicatively coupled with eyewear device 2502 and/or to other devices. These other devices may provide certain functions (e.g., tracking, localizing, depth mapping, processing, storage, etc.) to augmented-reality system 2500. In the embodiment of FIG. 25, neckband 2505 may include two acoustic transducers (e.g., 2520(I) and 2520(J)) that are part of the microphone array (or potentially form their own microphone subarray). Neckband 2505 may also include a controller 2525 and a power source 2535.

Acoustic transducers 2520(I) and 2520(J) of neckband 2505 may be configured to detect sound and convert the detected sound into an electronic format (analog or digital). In the embodiment of FIG. 25, acoustic transducers 2520(I) and 2520(J) may be positioned on neckband 2505, thereby increasing the distance between the neckband acoustic transducers 2520(I) and 2520(J) and other acoustic transducers 2520 positioned on eyewear device 2502. In some cases, increasing the distance between acoustic transducers 2520 of the microphone array may improve the accuracy of beamforming performed via the microphone array. For example, if a sound is detected by acoustic transducers 2520(C) and 2520(D) and the distance between acoustic transducers 2520(C) and 2520(D) is greater than, e.g., the distance between acoustic transducers 2520(D) and 2520(E), the determined source location of the detected sound may be more accurate than if the sound had been detected by acoustic transducers 2520(D) and 2520(E).

Controller 2525 of neckband 2505 may process information generated by the sensors on neckband 2505 and/or augmented-reality system 2500. For example, controller 2525 may process information from the microphone array that describes sounds detected by the microphone array. For each detected sound, controller 2525 may perform a direction-of-arrival (DOA) estimation to estimate a direction from which the detected sound arrived at the microphone array. As the microphone array detects sounds, controller 2525 may populate an audio data set with the information. In embodiments in which augmented-reality system 2500 includes an inertial measurement unit, controller 2525 may compute all inertial and spatial calculations from the IMU located on eyewear device 2502. A connector may convey information between augmented-reality system 2500 and neckband 2505 and between augmented-reality system 2500 and controller 2525. The information may be in the form of optical data, electrical data, wireless data, or any other transmittable data form. Moving the processing of information generated by augmented-reality system 2500 to neckband 2505 may reduce weight and heat in eyewear device 2502, making it more comfortable to the user.

Power source 2535 in neckband 2505 may provide power to eyewear device 2502 and/or to neckband 2505. Power source 2535 may include, without limitation, lithium ion batteries, lithium-polymer batteries, primary lithium batteries, alkaline batteries, or any other form of power storage. In some cases, power source 2535 may be a wired power source. Including power source 2535 on neckband 2505 instead of on eyewear device 2502 may help better distribute the weight and heat generated by power source 2535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 2600 in FIG. 26, that mostly or completely covers a user's field of view. Virtual-reality system 2600 may include a front rigid body 2602 and a band 2604 shaped to fit around a user's head. Virtual-reality system 2600 may also include output audio transducers 2606(A) and 2606(B). Furthermore, while not shown in FIG. 26, front rigid body 2602 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 2500 and/or virtual-reality system 2600 may include one or more liquid crystal displays (LCDs), light emitting diode (LED) displays, microLED displays, organic LED (OLED) displays, digital light processing (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2500 and/or virtual-reality system 2600 may include micro-LED projectors that project light (using, e.g., a waveguide) into display devices, such as clear combiner lenses that allow ambient light to pass through. The display devices may refract the projected light towards a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2500 and/or virtual-reality system 2600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an electrostrictive ceramic that comprises or includes PMN-PT include embodiments where an electrostrictive ceramic consists of PMN-PT and embodiments where an electrostrictive ceramic consists essentially of PMN-PT.

What is claimed is:

1. An apparatus comprising:
a substrate;
an actuator; and
a spring member disposed between the substrate and the actuator, wherein:
the spring member comprises a flexure that at least partially surrounds a central region; and
a spring stiffness of the flexure differs at each of at least two peripheral locations around the central region.

2. The apparatus of claim 1, wherein the flexure extends between the actuator and the substrate along a path that protrudes radially outward or inward with respect to the central region.

3. The apparatus of claim 2, wherein the flexure has a generally V-shaped cross-sectional surface.

4. The apparatus of claim 2, wherein the flexure protrudes radially outward or inward to a different extent at each of the at least two peripheral locations.

5. The apparatus of claim 1, wherein the flexure comprises a resilient material.

6. The apparatus of claim 5, wherein the flexure comprises a different resilient material or combination of resilient materials at each of the at least two peripheral locations.

7. The apparatus of claim 6, wherein the resilient material or combination of resilient materials has a different Young's modulus at each of the at least two peripheral locations.

8. The apparatus of claim 1, wherein the spring member further comprises:
a base surface adjacent the substrate; and
an actuation surface adjacent the actuator.

9. The apparatus of claim 8, wherein the actuation surface overlaps the base surface between the actuator and the substrate.

10. The apparatus of claim 8, wherein a distance between the actuation surface and the base surface differs at each of the at least two peripheral locations.

11. The apparatus of claim 1, wherein the actuator comprises an electromechanical actuator configured to compress the flexure in response to a change in voltage applied to the electromechanical actuator.

12. The apparatus of claim 11, wherein the electromechanical actuator comprises at least one piezoelectric layer.

13. The apparatus of claim 1, wherein the flexure has a different layer thickness at each of the at least two peripheral locations.

14. A fluid lens comprising the apparatus of claim 1.

15. A fluid lens comprising:
a substrate;
an actuator;
a fluid layer disposed between the substrate and the actuator; and
a spring member disposed between the substrate and the actuator, wherein:
the spring member comprises a flexure that at least partially surrounds the fluid layer; and
a spring stiffness of the flexure differs at each of at least two peripheral locations around the fluid layer.

16. The fluid lens of claim 15, wherein the spring member seals the fluid between the substrate and the actuator.

17. The fluid lens of claim 15, wherein the spring member defines a noncircular profile around the fluid layer.

18. A method comprising:
positioning a spring member over a substrate;
positioning an actuator over the spring member and the substrate such that an interior gap is defined between the substrate and the actuator with the interior gap at least partially surrounded by a flexure of the spring member, wherein a spring stiffness of the flexure differs at each of at least two peripheral locations around the interior gap; and
dispensing a fluid into the interior gap.

19. The method of claim 18, further comprising forming the spring member such that the spring stiffness of the flexure at each of the at least two peripheral locations results in a lens shape having a selected optical power and cylinder at each of at least two different voltages applied to the actuator.

20. The method of claim 18, wherein the spring member defines a noncircular profile around the fluid.
